(19) United States
(12) Patent Application Publication
(10) Pub. No.: US 2010/0057603 A1
(43) Pub. Date: Mar. 4, 2010

(54) METHOD AND APPARATUS FOR TRADING FINANCIAL INSTRUMENTS BASED ON A MODEL OF ASSUMED PRICE BEHAVIOR

(75) Inventor: Braden S. Janowski, Tulsa, OK (US)

Correspondence Address: TRADEHELM, INC., 5727 S. LEWIS AVE, STE. 500, TULSA, OK, 74105, US

(73) Assignee: TradeHelm, Inc., Tulsa, OK (US)

(21) Appl. No.: 12/237,329

(22) Filed: Sep. 24, 2008

Related U.S. Application Data
(63) Continuation-in-part of application No. 12/200,228, filed on Aug. 28, 2008.

(51) Int. Cl. G06Q 40/00

(52) U.S. Cl. 705/37

(57) ABSTRACT

A model of assumed price behavior of a financial instrument is used in trading the financial instrument. The model includes one or more analytic levels containing analytic values divided into nodes where each node is associated with a future price indicator (such as a price offset) of the financial instrument for a particular look ahead interval. For each analytic level of the model, a current analytic value is related to one of the nodes of that analytic level and a trade order is generated when the future price indicator associated with a node to which the current analytic value relates meets a trader's criteria for trading the instrument. Generated trade orders may rest on the book or be filled immediately. Resting orders may be re-priced as market conditions or current analytic values change. Optionally, a trader may specify an edge that triggers submittal of the trade order to an exchange when the future price indicator meets the inverse of the specified edge value. For round trip orders, the trader may specify a hedge offset that is added to the trade price calculation to help ensure the second leg of the round trip order gets filled. Trade orders may be generated when one or all analytic levels of the model indicate favorable trading conditions.

### CROSS REFERENCE TO RELATED APPLICATION

This application is a continuation-in-part of U.S. patent application Ser. No. 12,200,228, filed Aug. 28, 2008, and titled “Data Analysis Method And Apparatus For Use In Trading Financial Instruments”.

### FIELD OF THE INVENTION

The invention relates in general to electronic trading of financial instruments. More particularly, the invention relates to a method and apparatus that employs a predictive model of assumed price behavior to generate trade orders for a financial instrument when a future price indicator meets a trader's trading criteria.

### BACKGROUND OF THE INVENTION

Electronic trading of financial instruments such as stocks, bonds, futures, etc., has become commonplace. In fact, the popularity of electronic trading has led some exchanges throughout the world to completely eliminate more traditional forms of trading, such as open outcry.

To successfully trade financial instruments in today's electronic environment, traders must develop trading strategies aimed at identifying favorable trading opportunities and act quickly when market conditions are deemed favorable according to the strategy employed. A typical trading strategy may involve analysis of historical market data to identify favorable trading opportunities. For example, analysis of historical data may show that when the market prices for two financial instruments differ by a certain amount or by a certain ratio, a buying opportunity exists for the instrument with the lower market price. In effect, the trader is predicting, based on historical events, the future price of the financial instrument. Once the trader recognizes this buying opportunity, the trader submits a Buy order for the instrument at the desired price.

One difficulty with using such a trading strategy is that the tools employed by traders to analyze historical market and identify favorable trading opportunities in real-time market data are often separate from the trading platform used to launch trade orders. For example, a trader may utilize one tool to record market data, another tool to analyze the recorded data, and a third tool that implements a trading strategy to identify when current market conditions reflect a favorable trading opportunity based on historical data. Such third tool may be in the form of a spreadsheet that requires manual data entry and updates. This cumbersome, manual process delays the trader's ability to act quickly in submitting trade orders when favorable market conditions are present. Such delay can mean the difference between the trader making a profit on the trade or taking a loss, particularly in fast-moving markets where favorable trading opportunities can be fleeting.

Traders are also limited by a current lack of analytical tools designed to build and implement multi-variant predictive price models on which trading decision may be based. As electronic trading comes of age, top tier traders must have access to analytical tools with advanced functionality if they are to maintain a competitive edge.

What is needed, therefore, is an improved method and apparatus that enables traders to efficiently build and implement advanced trading strategies utilizing a predictive model of assumed price behavior.

### SUMMARY OF THE INVENTION

The present invention can be summarized as a computer-implemented method for trading a financial instrument based on a model of assumed price behavior of the financial instrument. The predictive model includes one or more analytic levels with each analytic level having a plurality of analytic values divided into two or more nodes where each node is associated with a future price indicator, such as a price offset representing an assumed future price of the financial instrument. A current analytic value is produced in real time for each of the analytic levels and each current analytic value is related to one of the nodes of a corresponding analytic level of the predictive model. One or more trade orders and then generated for trading the financial instrument at one or more electronic exchanges at a trade price that is determined based on the future price indicator associated with a node to which the current analytic value relates.

Trade orders may be generated when the future price indicator of all nodes meets the trader's criteria for trading. Alternatively, trade orders are not generated unless the future price indicator for all nodes of the predictive model meet the trader's criteria for trading.

The future price indicator can be measured in a number of ways. In one embodiment, the future price indicator is measured in units of the financial instrument's tick size. In another embodiment, the future price indicator is measured in units of a currency amount.

Trade orders generated according to the method may include resting orders that are submitted to an exchange which rest on an order book until the future price indicator meets the trader's criteria for trading. Snipe orders may also be submitted and immediately filled when the future price indicator meets the trader's trading criteria.

Round trip orders may also be submitted, including a first trade order that is traded at the trade price, and a second trade order that is submitted at a round trip price that is different than the fill price where the difference between the trade price and round trip price represents the trader's profit. If a trader has specified a second trade order offset for the purpose of increasing the likelihood of getting the round trip leg filled, then the second round trip order will be submitted at the fill price of the first trade order minus the future price indicator plus the second trade order offset.

Analytic values contained within the predictive model may vary greatly in nature. For example, traders who prefer to trade based on actual past price performance of an instrument may produce the analytic values from a mathematical analysis of market data. A trader may also specify the analytic values contained with the model.

The present invention also provides an apparatus for allowing a trader to submit trade orders for a financial instrument from an electronic processing device to an electronic exchange according to the method described above. The apparatus includes a graphical user display device, a user input device, a communications network for electronically communicating with an electronic exchange, and a programmable electronic processing in communication network. The electronic processing device is programmed to implement the method described above.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawing (which are not to scale) where:

FIG. 1 is a functional block of an apparatus for analyzing data related to a tradable financial instrument according to the invention;

FIG. 2 is a flow diagram of a method for analyzing data related to a tradable financial instrument according to the invention;

FIG. 3 is a screenshot of a design screen for use in analyzing data related to a tradable financial instrument;

FIG. 4 is a screenshot of a design screen showing a listing of raw market data files;

FIG. 5 is a screenshot showing the contents of an Aliases folder;

FIG. 6 is a screenshot of an Alias parameter setting screen showing settings for a portion of the parameters;

FIG. 7 is a screenshot of a screen for defining a date range for an Alias;

FIG. 8 is a screenshot of the Alias parameters setting screen of FIG. 6 with all parameters set;

FIG. 9 is a screenshot of the design screen of FIG. 3 showing the content of Aliases and Analytic Template folder;

FIG. 10 is a screenshot of a screen for naming a new analytic equation to be created;

FIG. 11 is a screenshot of the design screen of FIG. 9 showing a Java shell program for use in defining an analytic equation;

FIG. 12 is a screenshot of the design screen of FIG. 9 showing a newly created Analytic Template file;

FIG. 13 is a screenshot of an Analytics Instance Configuration screen for use in selecting a type of Analytics Instance;

FIG. 14 is a screenshot of a screen for setting parameters of the Analytics Instance type selected in FIG. 13;

FIG. 15 is a screenshot of a screen for naming an Analytics Instance;

FIG. 16 is a screenshot of a design screen showing data files available for processing with a defined analytic equation;

FIG. 17 is a screenshot of the design screen of FIG. 16 as data is being processed by an analytic equation;

FIG. 18 is a screenshot of the design screen of FIG. 16 showing data files that have been processed;

FIG. 19 is a screenshot of a screen for setting the node walls of a histogram of processed data;

FIG. 20 is a screenshot showing the histogram generated from the node wall settings of FIG. 19;

FIG. 21 is a screenshot showing data graphs for processed and unprocessed data;

FIG. 22 is a screenshot of a screen for setting numeric sweep parameters;

FIG. 23 is a screenshot of a screen for setting parameters for use in determining a Future Trade Price Offset (FTPO) for analytic values produced by an analytic equation;

FIG. 24 is a screenshot of a screen for selecting Bid Analytics;

FIG. 25 is a screenshot of a screen for selecting Ask Analytics;

FIG. 26 is a screenshot of a screen for naming a finite state decision tree;

FIG. 27 is a screenshot of a design screen showing parameters settings for a finite state decision tree;

FIG. 28 is a screenshot of a screen for selecting trade dates for use in building a finite state decision tree;

FIG. 29 is a screenshot of a design screen showing decision tree metrics;

FIG. 30 is a screenshot of a screen for selecting multiple decision trees to combine into a composite design tree;

FIG. 31 is a screenshot of a screen for naming a composite decision tree;

FIG. 32 is a screenshot of a screen showing composite decision tree metrics;

FIG. 33 is a screenshot of a screen for adjusting the manner in which metrics are displayed in FIG. 32;

FIG. 34 is a screenshot of a design screen redisplaying the metrics of FIG. 32 in accordance with adjustments made in FIG. 33;

FIG. 35 is a screenshot of a screen showing multiple analytic instances for producing a multi-level decision tree;

FIG. 36 is a screenshot of a screen showing multi-level decision tree metrics;

FIG. 37 is a diagram showing the general structure of a two-level decision tree;

FIG. 38 is a diagram of an apparatus suitable for submitting trade orders to an electronic exchange;

FIG. 39 is a block diagram of a server shown in FIG. 38;

FIG. 40 is a screenshot of a screen for specifying a name and other parameters for a trading session;

FIG. 41 is a screenshot of a screen for specifying additional parameters for a trading session;

FIG. 42 is a screenshot of a screen for selecting a decision tree configuration in connection with setting parameters in FIG. 41;

FIG. 43 is a screenshot of the screen of FIG. 41 showing the decision tree configuration selected in FIG. 42;

FIG. 44 is a screenshot of a screen for selecting a decision tree in connection with setting parameters in FIG. 41;

FIG. 45 is a screenshot of the screen of FIG. 41 showing the decision tree selected in FIG. 44;

FIG. 46 is a screenshot of a screen for launching a trading session and monitor trade orders submitted during the trading session;

FIG. 47 is a screenshot of a graphical control interface for generating trade orders based on a trader specified edge value;

FIG. 48 is a screenshot of a screen showing two trade orders submitted to an exchange resting in the marketplace; and

FIG. 49 is a screenshot of the screen of FIG. 46 showing the particulars of trade orders submitted during a trading session.

### DETAILED DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The term “the” is used numerous times throughout the disclosure of this patent as a definite article referring to one or more objects that relate to a particular embodiment(s) being described. No such use of “the” should be interpreted as limiting the scope of the invention to only the embodiment(s) being described unless specifically stated otherwise.

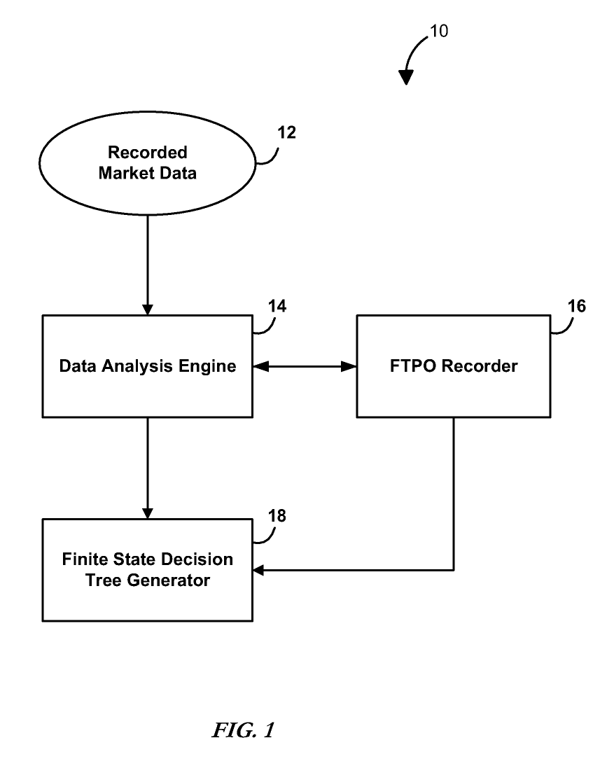

Turning now to the drawings wherein like reference characters indicate like or similar parts throughout, FIG. 1 is a functional block diagram showing a computer-implemented apparatus 10 for analyzing data related to a tradable financial instrument. The apparatus 10 includes a data analysis engine 14 for analyzing data, such as recorded market data 12, related to a tradable financial instrument such as a stock, futures contract, option, synthetic instrument, etc. The recorded market data 12 preferably contains all information relating to trading activity for the financial instrument over an historical time period and may be recorded by a market data recorder incorporated into the apparatus 10 or, alternatively, may be obtained from a data vendor or other external source.

For purposes of clarity, pre-recorded market data for a particular financial instrument is discussed herein in connection with a preferred embodiment of the method and apparatus. However, it will be understood that a variety of data types (included pre-recorded and real time) may be analyzed according to the method and apparatus. In addition to market data, the method and apparatus described herein may be used to analyze news and other data feeds such as RSS (Rich Site Summary), emails, time, and others.

The data analysis engine 14 includes the necessary programming and processing capability to perform analytical processing, as described herein, on the recorded market data 12. In general, analytic values are produced by the data analysis engine 14, a future price indicator, such as a Future Trade Price Offset (FTPO), is determined and recorded by a FTPO Recorder 16, and the recorded FTPOs are associated with the analytic values by a finite state decision tree generator 18. The future price indicator may also be an actual price for the instrument or any other type of number, value, symbol or other object that functions to represent an assumed future price of the financial instrument.

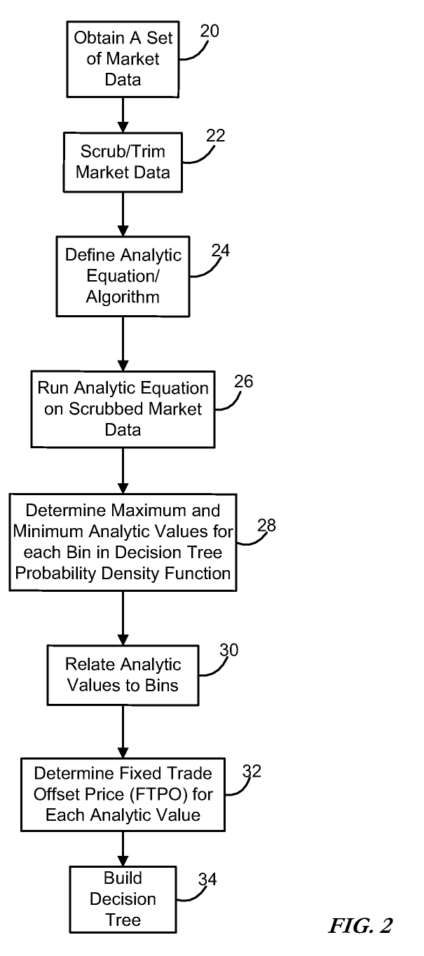

FIGS. 2A-2B provides a more detailed breakdown of a preferred method for building a predictive model representing assumed price behavior of a financial instrument. In a preferred embodiment described herein, the predictive model is implemented as a decision tree. In accordance with the method of FIGS. 2A-2B, a set of data, such as market data, is obtained 20 and optionally scrubbed or trimmed 22 as deemed necessary according to the trader's particular trading strategy. Market data may be scrubbed in a number of ways, including filtering the data to remove data lying outside a particular time period or to remove erratic data that may have resulted from a particular event that occurs only once or infrequently. It is envisioned that scrubbing the data will be particularly useful in connection with trading strategies that looks only at market data that is reflective of activity that occurs during certain trading hours with the exchanges.

An analytic equation/algorithm is defined 24 and parameterized with the market data (or scrubbed market data) to create an analytic instance that produces a plurality of analytic values 26. The analytic equation used by the trader may be selected from an analytic equation template stored in an electronic memory in communication with the data analysis engine 14, or the analytic equation may be defined by the trader in real time. A maximum and minimum analytic value is determined for each node in the decision tree 28 to produce what is, in essence, a probability density function for the analyzed data. Here, it should be noted that the end node with the lowest analytic values may be open to negative infinity and the end node with the highest analytic values may be open to positive infinity. For purposes of this disclosure, negative infinity and positive infinity are considered minimum and maximum analytic values, respectfully. Each of the analytic values is related to a particular node of the decision tree 30.

At this point, the trader has created an analytic instance on which the decision tree may be based. The trader may choose to build the decision tree from this newly created analytic instance, or the trader may choose some other analytic instance or even multiple analytic instances if a multi-level decision tree is desired.

The trader selects one or more analytic instances 32 and also selects a financial instrument the trader wishes to trade 34. Selection of a financial instrument to trade may occur earlier in the process shown in FIGS. 2A-2B, and the selected financial instrument may be an instrument for which no market data is included in the analyzed set of market data. In other words, the process of FIGS. 2A-2B enables analyzed market data for one instrument to be used as a basis for trading a different selected instrument. A future price indicator, such as a Future Trade Price Offset (FTPO), representing a prediction for a future price change of the financial instrument, is determined for each analytic value 36. The FTPO may be determined based on the difference between the market price (which could be calculated as last trade, best bid, best ask, volume weighted average price, etc) of the financial instrument when an analytic value is produced and the market price of the instrument at a later time, such as 2000 milliseconds. FTPO values may also be specified by the trader. Preferably, the FTPOs for each node of the decision tree are averaged to produce an FTPO for the node. Alternatively, the FTPOs for each node may be calculated as the Max, Min, median, weighted average, etc. The decision tree is then built from the analytic values and FTPO's for each node 38.

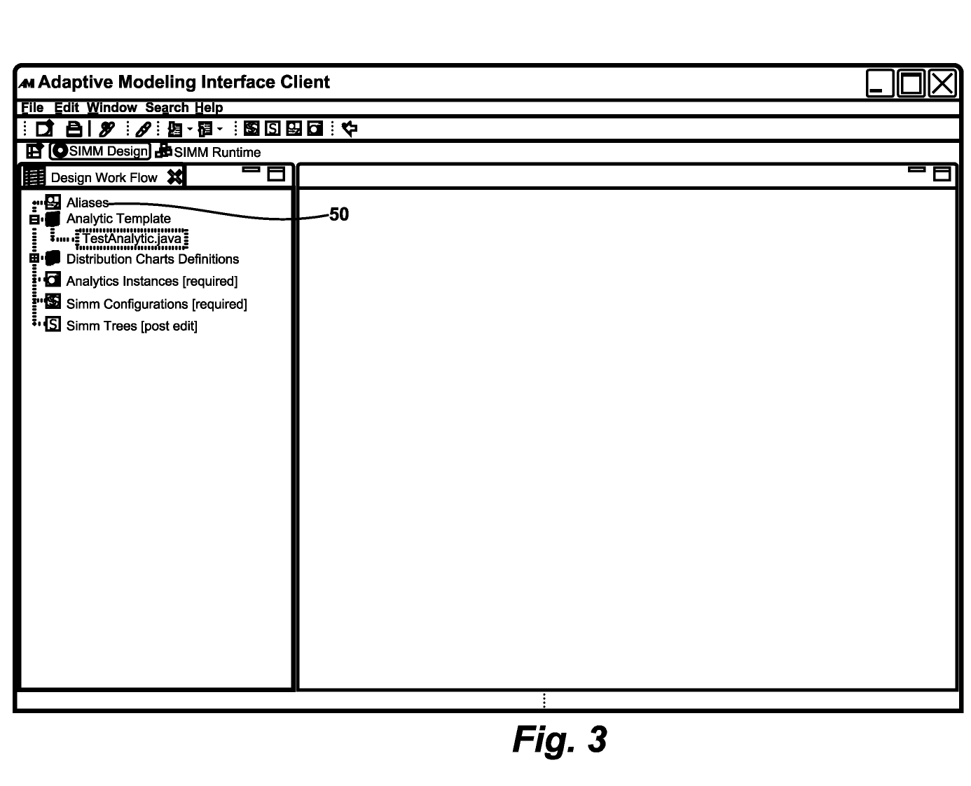

The method of FIGS. 2A-2B is implemented through computer software running on hardware with sufficient processing power and user interface controls (keyboard, multi-button mouse with onscreen pointer, etc.) to permit a trader to practice the method. The screenshots shown in FIGS. 3-28 illustrate one way in which the method may be implemented.

FIG. 3 shows a design screen from which a trader may navigate an analysis of market data according the method set forth in FIGS. 2A-2B. For the exemplary analysis that follows, it will be assumed that the trader has access to stored market data files containing the market data to be analyzed and does not need to verify the availability of the data. Typically, market data for financial instruments is stored in individual day files where each file contains market data that has been recorded for one day of trading activity on a particular exchange. The raw market data files may be recorded by the trader over time with a market data recorder, or the recorded raw market data files may be obtained from an external source, such a data vendor or the exchange itself.

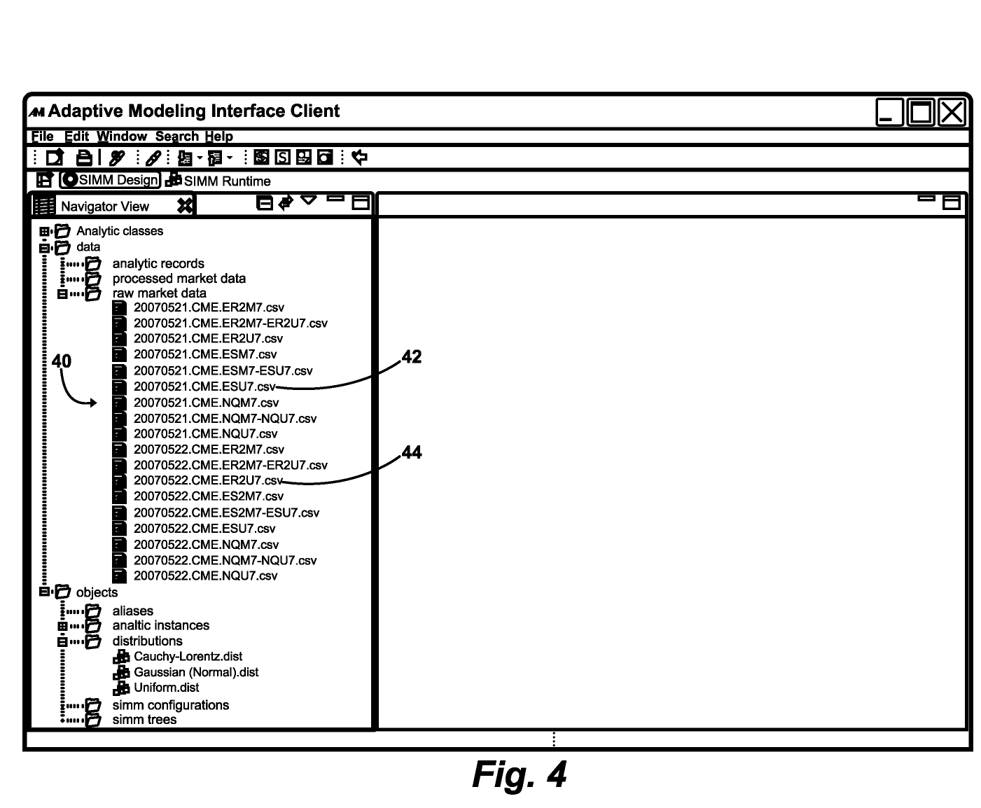

Each raw market data file name is preferably formatted to be easily recognized and distinguished from other market data files by the data analysis engine 14. In FIG. 4, the trader has opened a directory folder titled “raw market data” to obtain a listing, shown generally at 40, of accessible market data files. For this embodiment, the name of each market data file includes a date, an identifier for the exchange, and an identifier for the particular financial instrument. For example, the name for file 42 immediately tells the trader (and the data analysis engine 14) that this file contains raw market data generated as a result of trading activity occurring on May 21, 2007 at the CME for the S&P ES Mini futures contract for the month of June, 2007. The name for file 44 shows trading activity occurring on May 22, 2007 at the CME for the same June 2007 month of the ES Mini futures contract. Each file ends in “.csv”, which is the file type extension commonly used for raw market data files. Although a preferred embodiment of the invention employs the particular date.exchange.instrumentname.csv file name format discussed above, it will be understood that the data analysis engine 14 may be configured to easily recognize and distinguish raw market data file names having a different file name format. So the trader may, if desired, verify the availability of the market data needed to implement a desired trading strategy prior to initiating the market data analysis.

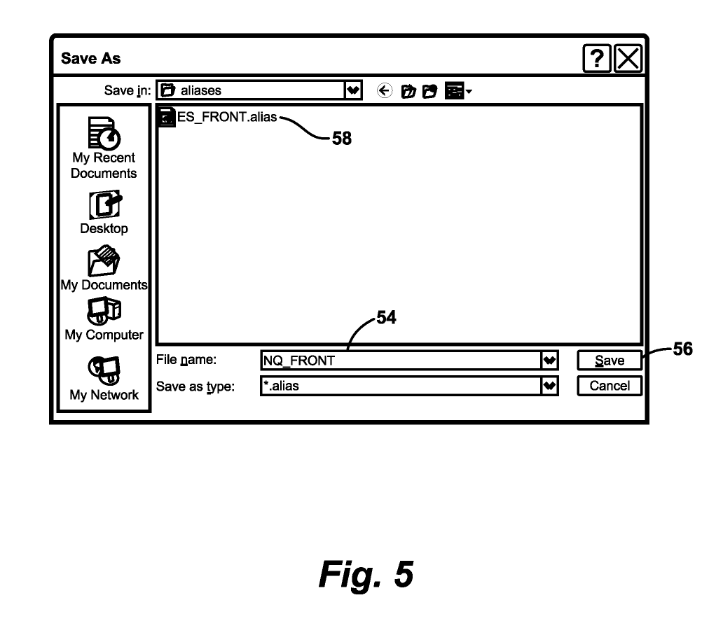

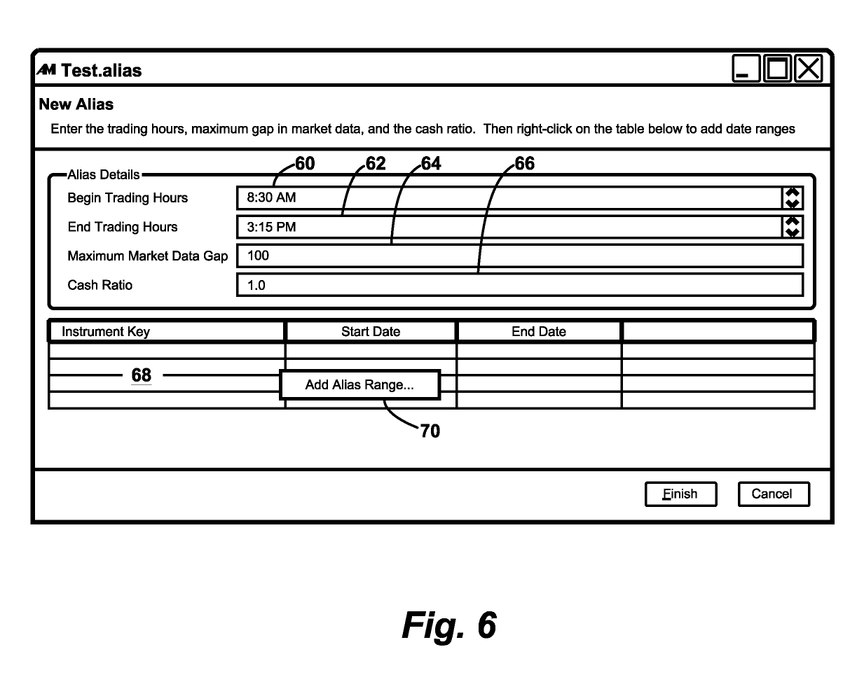

Referring again to the design screen of FIG. 3, the trader may initiate the process of building a finite state decision tree by activating (such as by clicking or double clicking) the “Aliases” folder 50. When alias folder 50 is activated, the alias naming screen shown in FIG. 5 is presented to the trader and a name for the alias to be created is selected or specified in file name window 54. Here, the trader has specified NQ_FRONT as the Instrument Alias name in window 54. While the trader may specify essentially any Instrument Alias name, most traders find it helpful to use a name that is descriptive of the market data to be analyzed. In this example, the trader has chosen NQ_FRONT because the market data the trader wishes to analyze is for the NASDAQ 100 E-Mini futures contract and the analysis will use market data that was generated from trading activity that occurred at a time considered to be the front month of the contract. When the trader clicks the Save button 56, the newly created NQ_FRONT.alias file 58 will appear in the Aliases folder directory as shown in FIG. 5 (as well as the Aliases folder shown in the design screen of FIG. 3) and the trader is presented with the screen shown in FIG. 6.

The screen shown in FIG. 6 provides a convenient and efficient way for a trader to set parameters that will determine how the raw market data in files 40 will be scrubbed or filtered when the trader's strategy involves an analysis of less than all of the data contained in a raw market data file 40. For example, if a trader's strategy involves analysis of only market activity that occurs during the exchange's specific trading hours, the trader may scrub/trim the raw market data to eliminate any data that is outside the exchange's open hours. Optionally, if the trader's strategy does not require scrubbing of the raw market data, the trader may proceed without performing this step.

As mentioned above, FIG. 6 enables the trader to define certain parameters that will control the raw market data scrubbing process. The parameters include trading hours, maximum market data gap, and cash ratio. These parameters are believed to be the most important and effective for traders who wish to scrub the raw market data. However, it will be understood that FIG. 6 may be configured to enable a trader to scrub raw market data according to additional and/or different parameters. The scrubbed data, being a sub-set of the raw market data, is generally referred to herein as an “Alias”.

In FIG. 6, the trader enters a time in the Begin Trading Hours window 60 that is typically reflective of the time that trading hours begin for the particular exchange. Here, the trader has entered 8:30 AM in window 60. And in the End Trading Hours window 62, the trader has entered 3:15 PM, which is typically reflective of the time that trading hours end for the particular exchange. Thus, when the Alias being defined in FIG. 6 is run on the raw market data, all data that falls outside of the time frame of 8:30 AM to 3:15 PM will be eliminated. A trader may wish to eliminate data falling outside the selected time period because the trader feels that the scrubbed data is too erratic or unreliable as an accurate predictor of future price changes. Accordingly, the trader removes this data from the predictive model of assumed price behavior being created.

Also in FIG. 6, the trader has set the parameter of Maximum Market Data Gap in window 64 to 100 milliseconds. In a preferred embodiment, this parameter setting will create a warning message in the log file created as the Alias scrubbing process runs that alerts the trader when the raw market data indicates a delay of at least 100 milliseconds in market activity for the financial instrument being analyzed. If enough warning messages are present in the log file, the trader may determine that the data is unreliable and adjust his/her trading strategy accordingly. If desired, the Alias scrubbing process may be configured to trim data reflective of market activity occurring within a certain time frame on either or both sides of any 100 millisecond time gaps. Cash ratio window 66 allows the trader to enter a multiplier that will be used to eliminate decimals and fractions in the price of financial instruments in order to simplify and speed the Alias scrubbing process. In FIG. 6, the Cash Ratio multiplier has been set to 1.0, which indicates that the price of the financial instrument is not in decimal or fractional form.

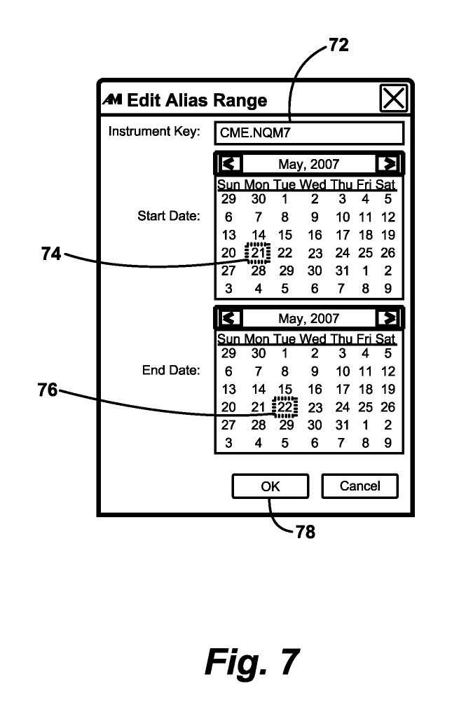

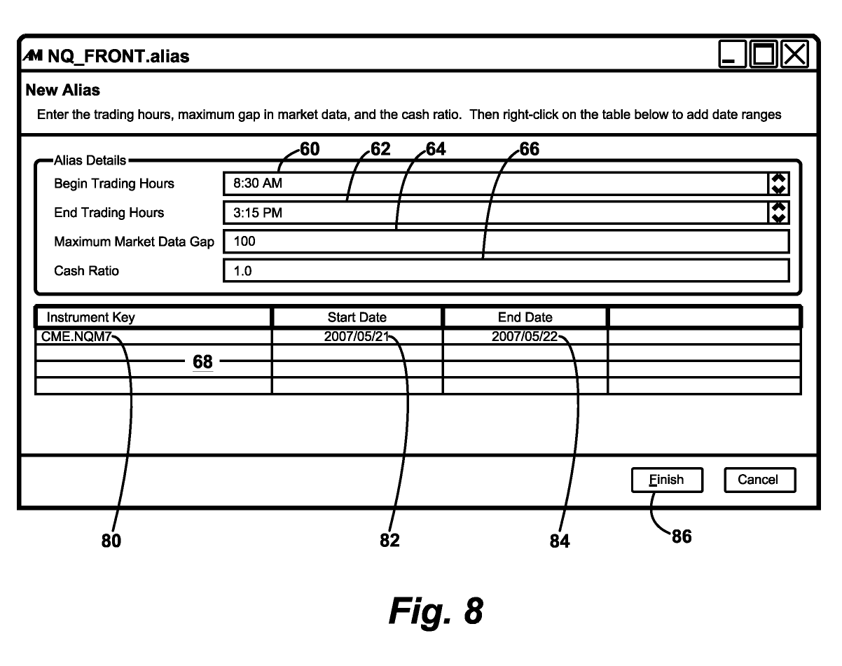

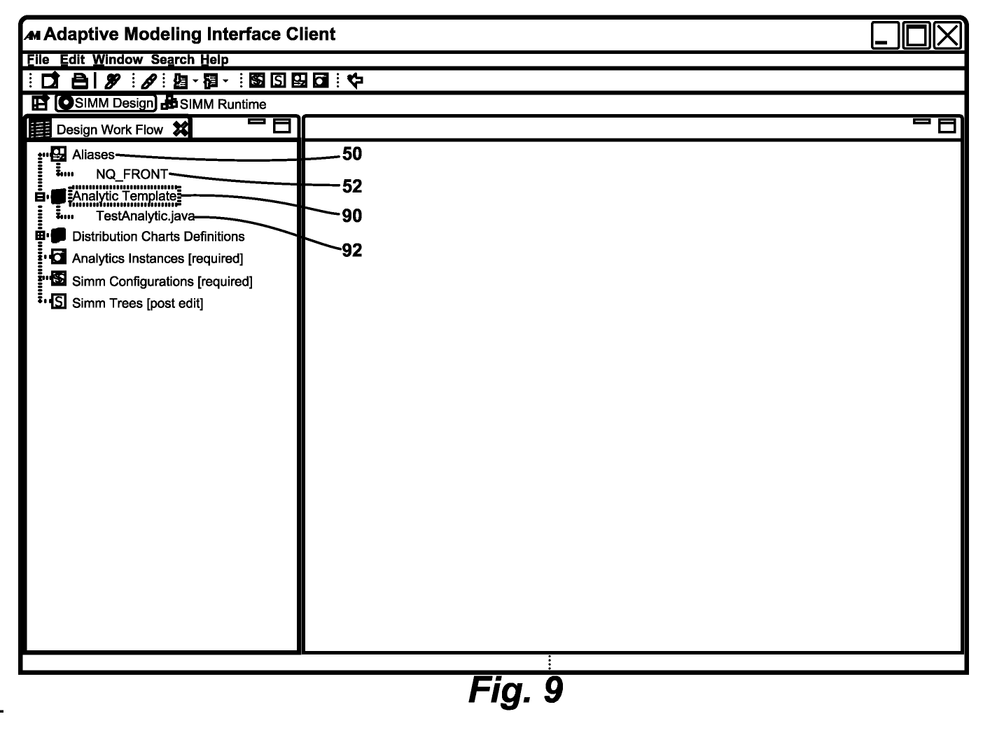

After the trader has populated windows 60-66, the trader activates (such by a right click with a computer mouse) instrument window 68, which pops up an Add Alias Range window 70 as shown. Window 70 is activated/clicked and the trader is presented with the screen shown in FIG. 7, which enables the trader to specify a financial instrument to be analyzed as well as start and end dates for the analysis. For example, in FIG. 7, the trader has entered “CME.NQM7” into Instrument Key window 72. This entry signifies that the trader wishes to scrub raw market data representing trading activity at the CME for the June 2007 month of the NASDAQ 100 E-Mini futures contract. The trader has selected (such as with a single mouse click) May 21, 2007 as the Start Date (generally indicated at 74). The selected Start Date 74 is highlighted to provide a visual confirmation of the selection. An End Date76 of May 22, 2007 has been selected for the scrubbing process. The selected End Date 76 is also highlighted to provide a visual confirmation of the selection. At this point, the trader clicks the “OK” button 78, which takes the trader back to the Alias parameter setting window as shown in FIG. 8 with instrument window 68 populated to show the Instrument Key 80, Start Date 82 and End Date 84 selected/specified in FIG. 7. If changes to the displayed parameters settings are needed, the trader may edit the parameter settings directly on the screen shown in FIG. 8. After the trader confirms all settings, the trader clicks Finish button 86, the raw market data files are scrubbed (or scrubbed at a later point in the data analysis process), and the trader is taken back to the design screen as shown in FIG. 9. The newly created NQ_FRONT Instrument Alias file 52 can be seen in FIG. 9 under the expanded Aliases folder 50.

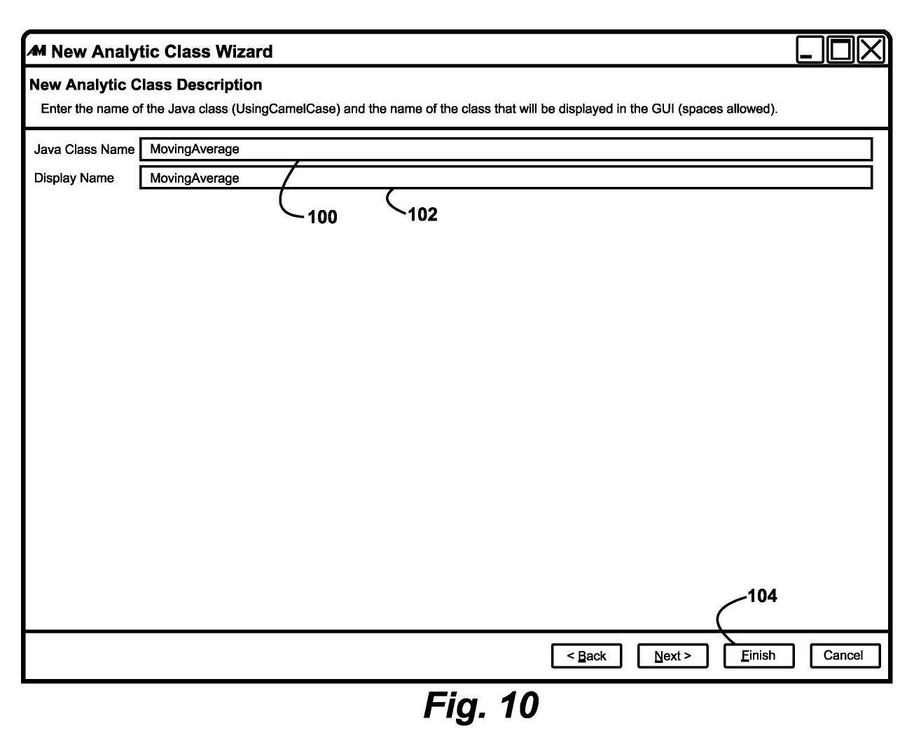

The trader is now ready to define an analytic equation or algorithm for performing an analysis of the scrubbed market data and activates Analytic Template folder 90 in the design screen of FIG. 9. The analytic equation can be any algorithm the trader desires, so long as the result produced by the algorithm is a number. If an analytic equation has been previously created and saved, it will appear in the Analytic Template folder 90 as a stored template when the trader opens the Analytic Template folder 90. In FIG. 9, a previously created analytic template file titled TestAnalytic.java 92 can be seen. The trader may use the TestAnalytic.java template 92 to analyze the scrubbed data by activating (such as double clicking) the template 92. If the trader wishes to create a new analytic equation, the trader may activate the Analytic Template folder 90 (such as by double clicking) and the analytic equation naming screen shown in FIG. 10 is presented to the trader.

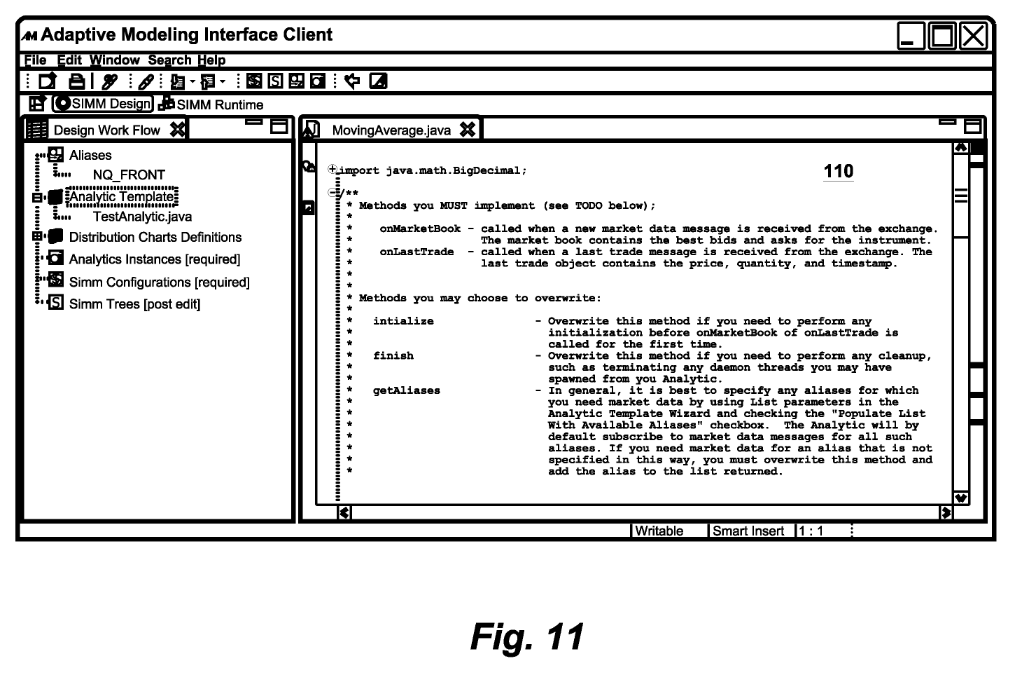

In FIG. 10, the trader specifies a name in Java Class Name window 100 for the particular analytic equation to be created. The analytic equation being created will be embodied in Java programming code, although it will be understood that other computer programming code languages may also be used to embody the analytic equation. In FIG. 10, the trader has entered “MovingAverage” as a descriptive name for the analytic equation to be defined. A Display Name window 102, which shows how the analytic equation will be displayed in the design screen of FIG. 3, is automatically populated with the name entered in window 100. If the trader wishes to have a different display name for the analytic equation, the trader may edit the name directly on the screen in window 102. After the content of windows 100, 102 is confirmed, the trader clicks the Finish button 104 and is brought back to the design screen, as shown in FIG. 11, with the right window 110 populated with a Java code shell program that the trader can use as a template to code the desired analytic equation. The complete Java code shell program (including comment lines) in window 110 is as follows:

import java.math.BigDecimal;
import java.math.RoundingMode;
import java.util.ArrayList;
import java.util.Arrays;
import java.util.Collection;
import java.util.List;
import com.tradehelm.actrader.api.MarketDataBook;
import com.tradehelm.actrader.api.MarketDataEntry;
import com.tradehelm.ami.core.analytics.Analytic;
import com.tradehelm.ami.core.analytics.AnalyticParameter;
import com.tradehelm.ami.core.analytics.AliasListParameter;
import com.tradehelm.ami.core.analytics.ListParameter;
import com.tradehelm.ami.core.analytics.NumericParameter;
import com.tradehelm.ami.core.analytics.TextParameter;
import com.tradehelm.ami.core.api.AnalogMarketData;
import com.tradehelm.ami.core.model.Alias;
/**
* Methods you MUST implement (see TODO below):
*
* onMarketBook - called when a new market data message is received from the exchange.
* The market book contains the best bids and asks for the instrument.
* onLastTrade - called when a last trade message is received from the exchange. The
* last trade object contains the price, quantity, and timestamp.
*
*
* Methods you may choose to overwrite:
*

| | |
|---|---|
| * initialize | - Overwrite this method if you need to perform any |
| * | initialization before onMarketBook or onLastTrade is |
| * | called for the first time. |
| * finish | - Overwrite this method if you need to perform any cleanup, |
| * | such as terminating any daemon threads you may have |
| * | spawned from your Analytic. |
| * getAliases | - In general, it is best to specify any aliases for which |
| * | you need market data by using List parameters in the |
| * | Analytic Template Wizard and checking the “Populate List |
| * | With Available Aliases” checkbox. The Analytic will by |
| * | default subscribe to market data messages for all such |
| * | aliases. If you need market data for an alias that is not |
| * | specified in this way, you must overwrite this method and |
| * | add the alias to the list returned. |

* getOnLastTradeAliases - Similar to getAliases, but more specific. This method

| | |
|---|---|
| * | specifies which aliases will subscribe to last trade |
| * | messages. Overwrite this method to return an empty list if |
| * | you do not use last trade messages. |

* getOnMarketBookAliases - Similar to getAliases, but more specific. This method

| | |
|---|---|
| * | specifies which aliases will subscribe to on market book |
| * | messages. Overwrite this method to return an empty list if |
| * | you do not use market book messages. |
| * | |
| * | |

* Methods you MUST call from your code:
*
* updateAnalyticValue - You must call this method each time you calculate a new value

| | |
|---|---|
| * | for the Analytic. This will typically be called from |
| * | onLastTrade and tonMarketBook. |

*
*
* Analytic methods you may find useful:
*
* getInstanceName - Returns the name of the Analytic Instance.
* getAliasDao - Returns an AliasDao object, which is useful for converting

| | |
|---|---|
| * | between Aliases and instument symbols. |

| | |
|---|---|
| * getDate | - Returns the analytic instance date (this does not equal |

| | |
|---|---|
| * | “new Date( )” when running on processed market data at design |
| * | time). |

*
*
* Other available methods you may find useful:
*
* AnalogMarketData.getAnalogAskPrice - returns the volume-weighted average of the

| | |
|---|---|
| * | best N asks in the given book, when N is the |
| * | “anchor quantity”. |

* AnalogMarketData.getAnalogBidPrice - returns the volume-weighted average of the

| | |
|---|---|
| * | best N bids in the given book, when N is the |
| * | “anchor quantity”. |

* AnalogMarketData.getAnalogMidpoint - returns the average of the analog ask price

| | |
|---|---|
| * | and the analog bid price: |
| * | (analogAskPrice + analogBidPrice)/2 |
| * | |

* RollingInterval class - useful for maintaining time based averaging
*
* constructor : RollingInterval(int window) - window is the interval time in milliseconds
* methods: BigDecimal getAverage( ); - returns null if time interval not filled

| | | |
|---|---|---|
| * | BigDecimal getMin( ) | - returns minimum value in current interval |
| * | BigDecimal getMax( ) | - returns maximum value in current interval |

| | |
|---|---|
| * | inputValue(long timeStamp, BigDecimal value) - adds data to the interval collection |
| */ | |

public class MovingAverage extends Analytic {
/**

* TODO (optional) Perform any additional initialization here. /*/
@Override
public void initialize( ) {
}
/**
* Called when a new market book message is received from the exchange.
*/
@Override
public void onMarketBook(long timestamp, String instrumentKey, MarketDataBook marketBook)

{

/*
* TODO: Implement this method. This method will usually need to call

updateAnalyticValue( )

* after calculating the new analytic value.
*/

}
/**
* Called when a last trade message is received from the exchange.
*/
@Override
public void onLastTrade(MarketDataBook marketDataBook, MarketDataEntry lastTrade) {

/*
* TODO: Implement this method. This method will usually need to call

updateAnalyticValue( )

* after calculating the new analytic value.
*/

}
/**
* You don't need to modify or call this method.
* This method returns the name of the Analytic Template as it will be displayed in the client.
*/
@Override
public String getDisplayName( ) {

return “MovingAverage”;

}
/**
* You don't need to modify or call this method.
* This method is called by the AMI client to render the GUI.
*/
@Override
public List<AnalyticParameter> getParameters( ) {

List<AnalyticParameter> params = new ArrayList<AnalyticParameter>( );
return params;

}

One skilled in the art of Java code programming, informed of the analytic equation to be embodied in Java code, is capable of using the above Java code shell program to embody the analytic equation in Java code. However, in the interest of full disclosure, the following Java program represents one example of how an analytic equation of the moving average class may be embodied in Java code.

import java.util.ArrayList;
import java.util.Iterator;
import java.util.List;
import com.tradehelm.ami.core.analytics.AliasListParameter;
import com.tradehelm.ami.core.analytics.Analytic;
import com.tradehelm.ami.core.analytics.AnalyticParameter;
import com.tradehelm.ami.core.analytics.NumericParameter;
import com.tradehelm.ami.core.api.AnalogMarketData;
import com.tradehelm.ami.core.common.InsufficientQuantityException;
import com.tradehelm.actrader.api.MarketDataBook;
import com.tradehelm.actrader.api.MarketDataEntry;
public class MovingAverage extends Analytic
{

private List<MarketData> mdList = new ArrayList<MarketData>( );
/**
* Return the name of the analytic that will be displayed in the client.
*/
@Override
public String getDisplayName( )
{

return “Moving Average”;

}
/**
* Used by the client to render the GUI.
*/
@Override
public List<AnalyticParameter> getParameters( )
{

List<AnalyticParameter> params = new ArrayList<AnalyticParameter>( );
params.add(new AliasListParameter(“Alias”, false));
params.add(new NumericParameter(“Anchor Qty”, false));
params.add(new NumericParameter(“WindowMs”, false));
params.add(new NumericParameter(“Trade Factor”, false));
return params;

}
/**
* Called when a new market book message is received from the exchange.
*/
@Override
public void onMarketBook(long timestamp, String instrumentKey, MarketDataBook

marketBook)

{

if (updateMDCollection(timestamp, marketBook))
{

updateAnalyticValue(timestamp, calcAnalytic( ));

}

}
/**
* Called when a last trade message is received from the exchange.
*/
@Override
public void onLastTrade(MarketDataBook marketDataBook, MarketDataEntry lastTrade)
{

long ts = marketDataBook.getLastUpdateTime( );
updateLTCollection(ts, lastTrade);
updateAnalyticValue(ts, calcAnalytic( ));

}
public boolean isValid( )
{

return true;

}
private void updateLTCollection(long ts, MarketDataEntry lastTrade)
{

// build new MarketData object
double price = lastTrade.getPrice( ).getValue( ).doubleValue( );
double qty = lastTrade.getQuantity( ).getValue( ).doubleValue( );
qty = qty * Double.parseDouble(getParameterValue(“Trade Factor”));
MarketData md = new MarketData(ts, price, qty);
updateList(ts, md, mdList);

}
private boolean updateMDCollection(long ts, MarketDataBook book)
{

// call getAnalogMidpoint to calculate valid average price for this book
String sAnchorQty = getParameterValue(“Anchor Qty”);
Integer bdAnchorQty = Integer.parseInt(sAnchorQty);
double price = 0.0;
double qty = 2.0 * bdAnchorQty.doubleValue( );
try
{

price = AnalogMarketData.getAnalogMidpoint(book,

bdAnchorQty).getValue( );

} catch (InsufficientQuantityException e)
{

return false;

}
MarketData md = new MarketData(ts, price, qty);
updateList(ts, md, mdList);
return true;

}
private void updateList(long ts, MarketData md, List<MarketData> list)
{

// Update current MarketData list based on current time, time window
List<MarketData> tempList = new ArrayList<MarketData>(list);
String sTimeWindow = getParameterValue(“WindowMs”);
Long iTimeWindow = new Long(sTimeWindow);
long timeWindow = iTimeWindow.longValue( );
long cutoff = ts − timeWindow;
// traverse collection - remove any out of ‘time window’ entries
Iterator<MarketData> i = tempList.iterator( );
while (i.hasNext( ))
{

MarketData m = (MarketData) i.next( );
long t = m.getTimeStamp( );
if (t < cutoff)

updateMD(“remove”, m);

}
updateMD(“add”, md);

}
synchronized private void updateMD(String function, MarketData md)
{

if (function.equals(“add”))

mdList.add(md);

if (function.equals(“remove”))

mdList.remove(md);

}
private double calcAnalytic( )
{

List<MarketData> list2 = new ArrayList<MarketData>(mdList);
Iterator<MarketData> i = list2.iterator( );
double numerator = 0.0;
double denominator = 0.0;
while (i.hasNext( ))
{

MarketData md = (MarketData) i.next( );
// MarketData md = null;
double qty = md.getQty( );
double price = md.getPrice( );
numerator = numerator + (qty * price);
denominator = denominator + qty;

}
Double dAnalytic = Double.NaN;
if (denominator != 0)
{

dAnalytic = new Double(numerator / denominator);

}
return dAnalytic;

}

}
class MarketData
{

private long timeStamp;
private double price;
private double qty;
MarketData(long timeStamp, double price, double qty)
{

this.timeStamp = timeStamp;
this.price = price;
this.qty = qty;

}
long getTimeStamp( )
{

return timeStamp;

}
double getPrice( )
{

return price;

}
double getQty( )
{

return qty;

}

}

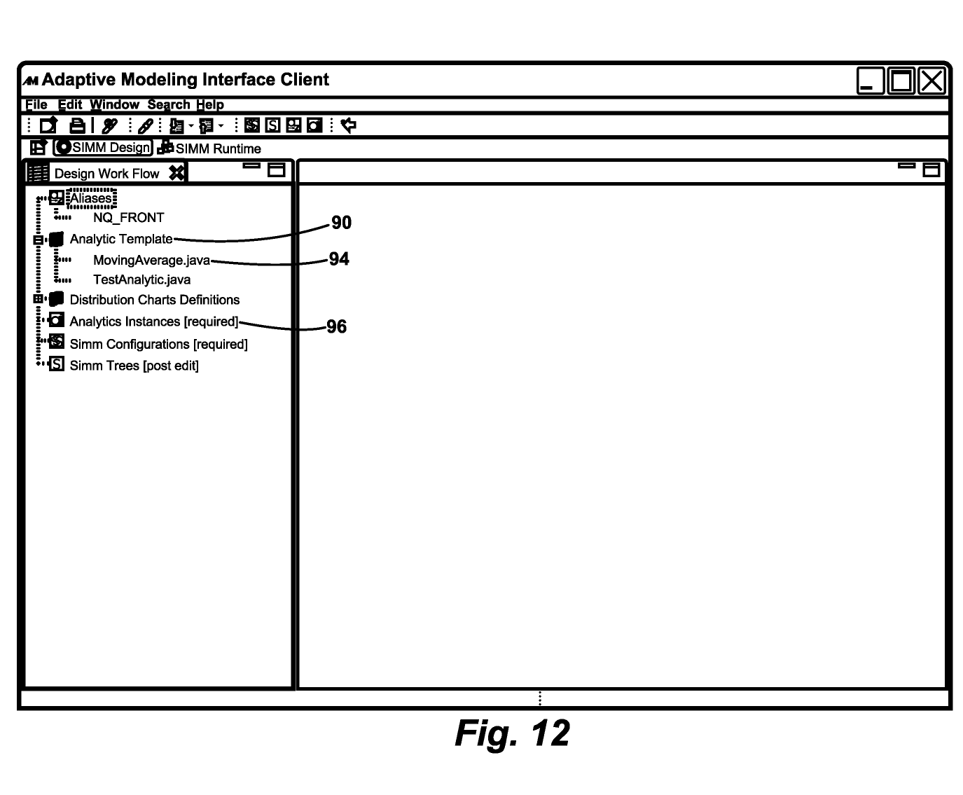

Once the desired analytic equation has been coded, the coded analytic equation is saved in the Analytic Template folder 90 and viewable from the design screen. As shown in FIG. 12, the newly created MovingAverage.java file 94 is now present under the expanded Analytic Template folder 90.

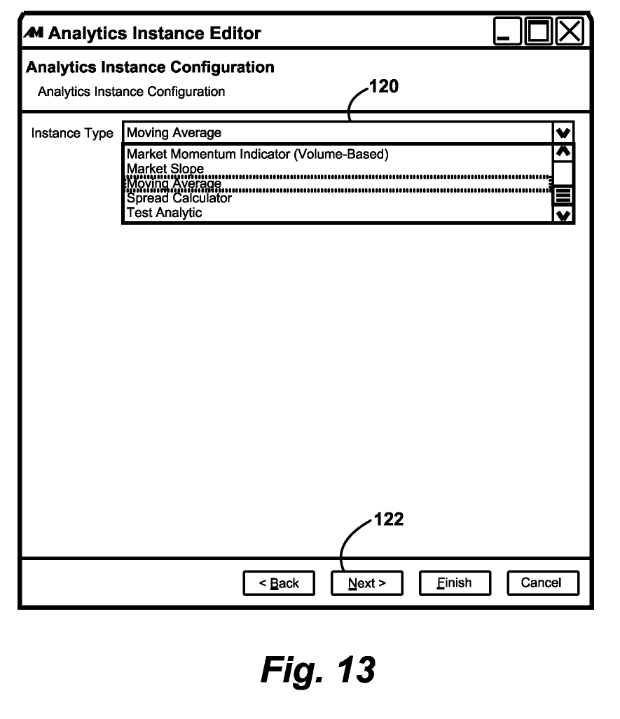

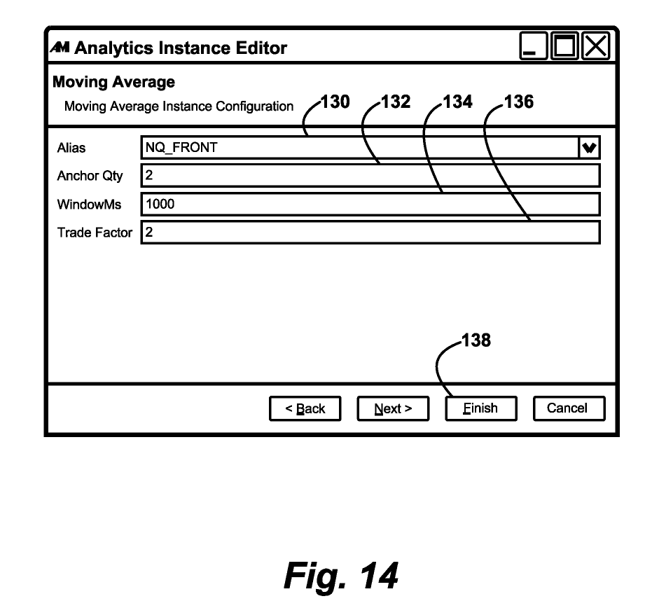

The trader is now ready to initiate configuration of an “analytic instance” that will define the analytic equation, data and other parameters that will be used to create the finite state decision tree. In effect, the analytic equation and the data combine to create an analytic instance. Configuration of an analytic instance is initiated by activating the “Analytics Instance [required]” folder 96 shown in FIG. 12, which presents the trader with the Analytics Instance Configuration screen shown in FIG. 13. In Instance Type window 120, the trader has selected “Moving Average” as the instance type and clicks the Next button 122, which presents the trader with the parameter setting screen shown in FIG. 14. It should be noted that the particular instance type selected by the trader in window 120 will determine which screen is presented to the trader for specifying/selecting the necessary analytic instance parameters.

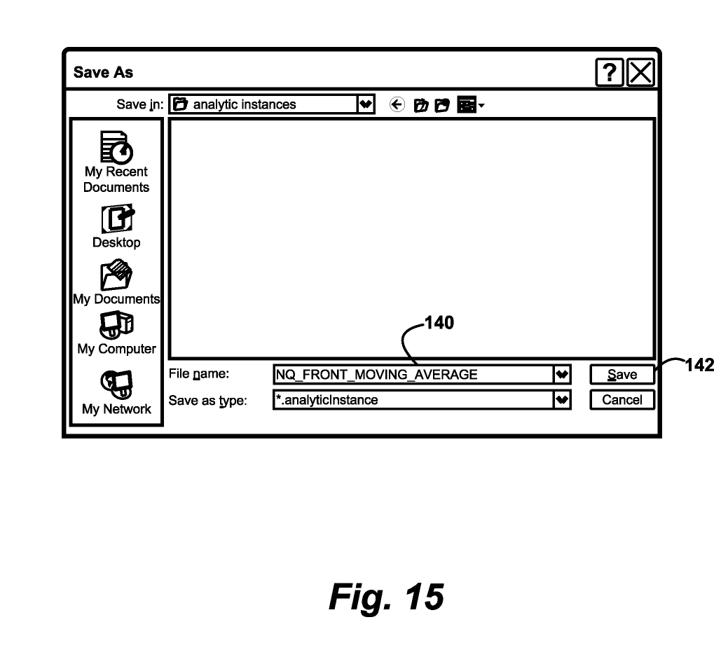

In FIG. 14, the trader has selected/specified the previously created Alias named NQ_FRONT” in Alias window 130. “Anchor Qty” is a parameter that essentially defines the trader's confidence level for each analytic value produced. Here, the trader has specified an anchor quantity of “2” in Anchor Qty window 132, which means that for each analytic value that is calculated there must be at least 2 resting trade orders on the book. If there are less than 2 resting trade orders on the book when the analytic value is calculated, the analytic value is discarded as being unreliable. In the “WindowMs” window 134, the trader has specified 1000 milliseconds as the time frame over which the moving average value will be calculated. And in Trade Factor window 136, a value of “2” has been specified as a weighting factor for trades that appear in the market data. Thus, by specifying a Trade Factor of “2”, the analysis will give greater weight to trades than resting book orders. After selecting/specifying the parameters for windows 130-136, the trader clicks the Finish button 138 and is presented with the screen shown in FIG. 15.

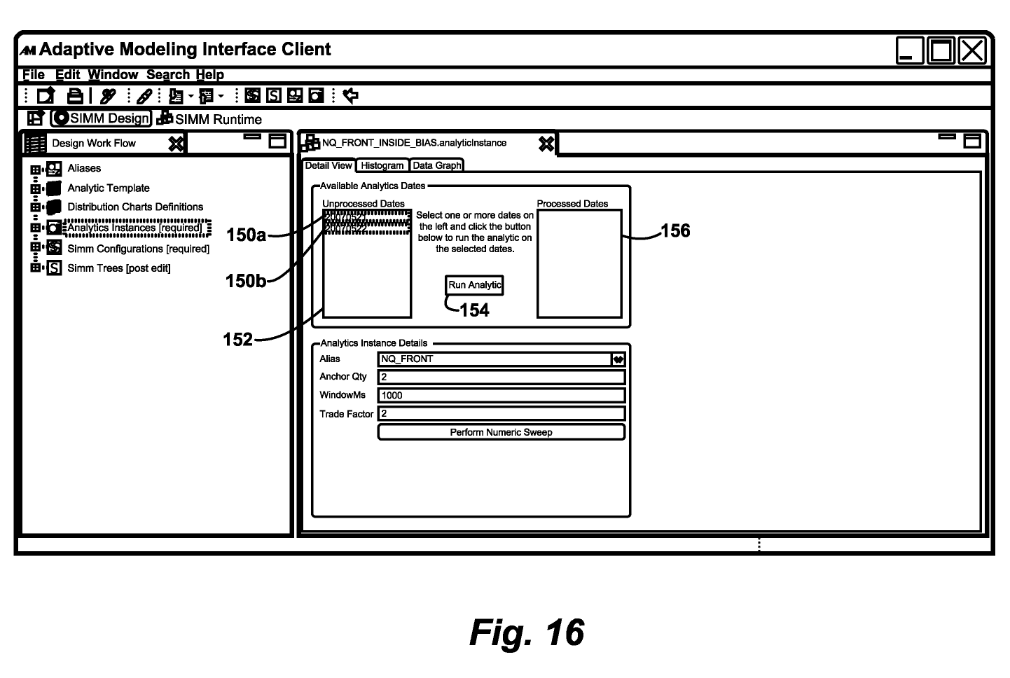

In FIG. 15, the trader has entered “NQ_FRONT_MOVING_AVERAGE” in File Name window 140 as the name of the analytic instance. The trader then clicks the Save button 142 to save the analytic instance, and the trader is presented with the screen shown in FIG. 16.

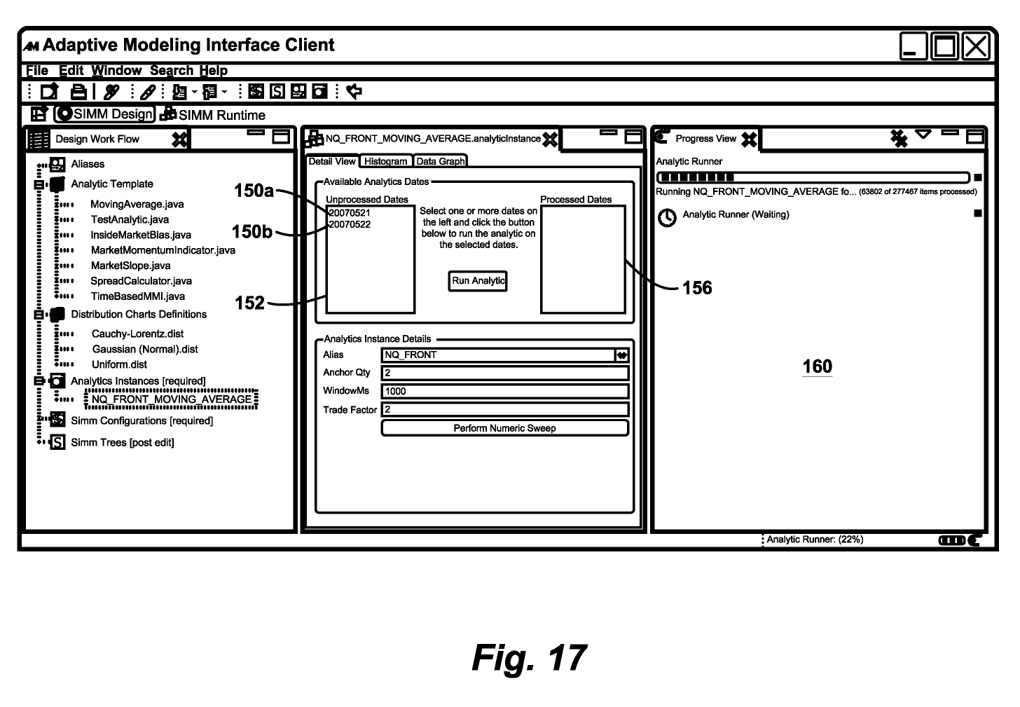

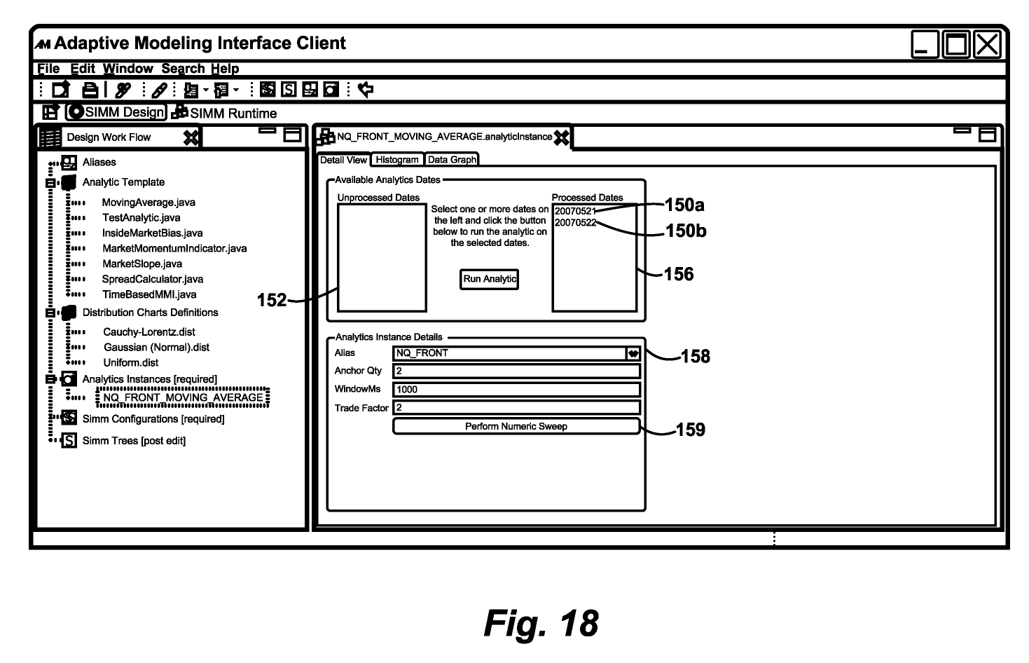

In FIG. 16, the trader is presented with a detailed view of the scrubbed raw market data files 150 that are ready to be processed according to the trader's MovingAverage analytic equation. The two raw market data files 150a, 150b shown in the Unprocessed Dates window 152 contain market data for the two trading days (May 21 and 22, 2007) that were defined earlier in FIG. 7. From the start and end dates selected in FIG. 7, the data analysis engine 14 found the scrubbed raw market data files 150a, 150b and populated window 152 with the dates for each. To run the analytic equation on the unprocessed data files 150a, 150b, the files 150a, 150b are selected (such as by clicking on each file). If desired, only one of the files 15a, 150b may be selected at a time. When selected, the files 150a, 150b will be highlighted as shown. The trader then clicks the Run Analytic button 154 and the trader is presented with the screen shown in FIG. 17 as the analytic equation runs the raw market data contained in the selected file(s) 150a, 150b. The analytic equation's progress can be monitored in progress window 160. When the analytic equation has run all of the scrubbed raw market data contained in the selected file(s) 150a, 150b, the processed data files 150a, 150b are moved from the Unprocessed Dates window 152 to the Processed Dates window 156, as shown in FIG. 18.

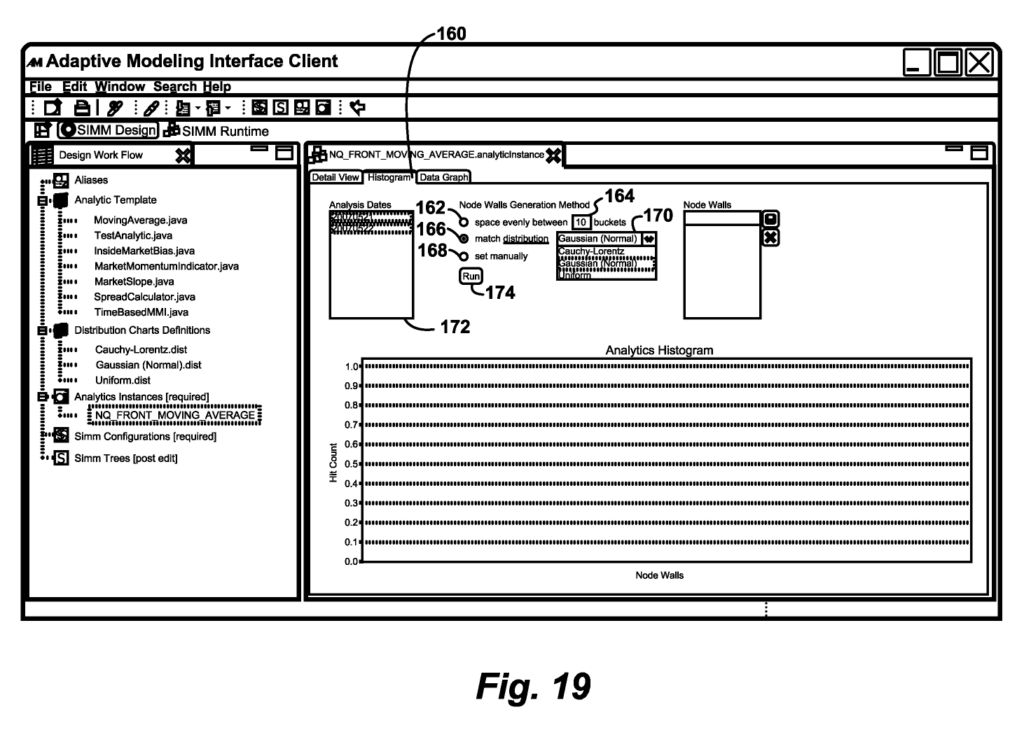

In FIG. 19, the trader has clicked the Histogram tab to generate a histogram from the analytic values that were produced when the analytic equation was run on the scrubbed market data. As previously discussed, analytic values produced by the analytic equation are in the form of numbers, and each analytic value is included in a range of numbers, which may be from negative infinity to positive infinity. In building a histogram from the analytic values, the trader must decide how the analytic values will be distributed in the histogram. The histogram includes node walls that separate the range of possible analytic values into sub-ranges (nodes or buckets) of possible analytic values. Each node wall establishes a boundary between two contiguous nodes, and each node is itself bounded by two node walls—one node wall as defined by an analytic value for the node, and a second node wall as defined by a minimum analytic value for the node.

The screen of FIG. 19 provides the trader with multiple options for setting the node walls of the histogram. The trader may designate an even spacing of the node walls by clicking radio button 162 and specifying the number of desired nodes or buckets in window 164. For example, when the trader clicks radio button 162 and specifies 10 nodes in window 164, data analysis engine 14 will create nine node walls dividing the possible range of analytic values into ten sub-ranges (nodes) of analytic values with each node containing an equal numbers of analytic values.

The trader has selected radio button 166 in FIG. 19 and a Gaussian distribution in pull-down window 170. Alternatively, the trader may choose to set the histogram node walls manually by clicking radio button 168.

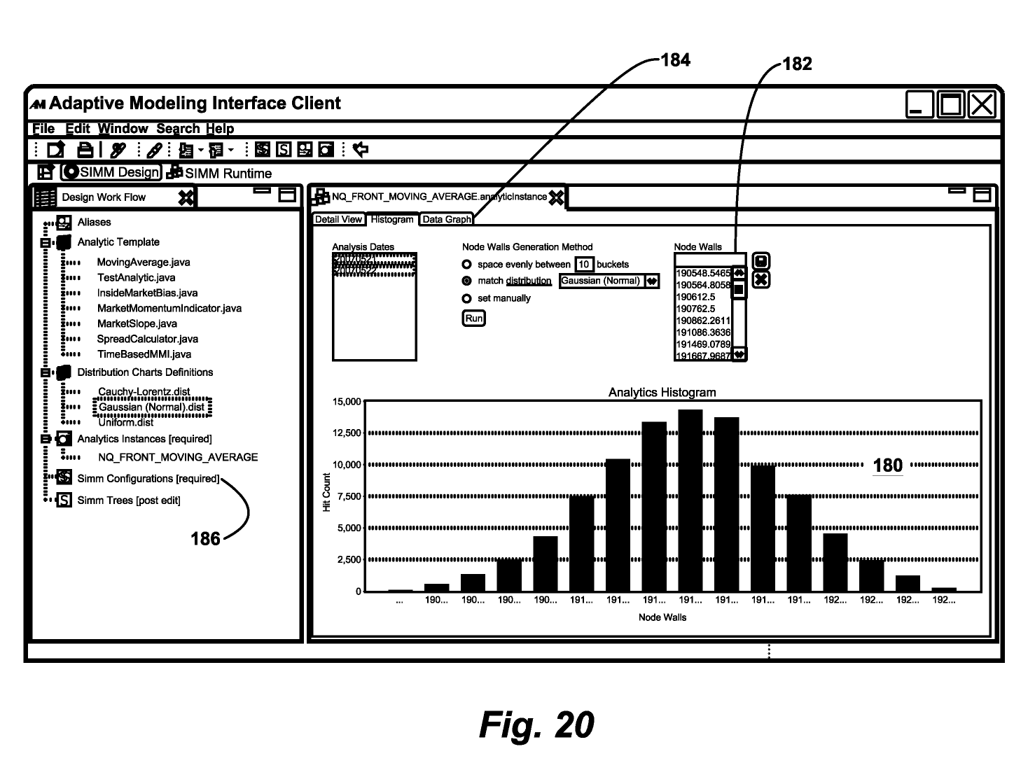

Once the trader has selected a node wall generation/distribution method and selected one or more of the Analysis Dates in window 172, the trader clicks Run button 174 and the data analysis engine 14 runs the histogram distribution for the analytic values produced for the date(s) selected in window 172. More particularly, the data analysis engine 14 relates each of the analytic values to one of the histogram nodes. The resultant histogram 180 showing the distribution of analytic values is displayed in FIG. 20. Histogram 180 shows the node walls on the horizontal axis and the number of analytic values (hits) for each node on the vertical axis according to the Gaussian distribution selected in FIG. 19. Node Walls window 182 displays the numerical value for each node wall in the histogram 180.

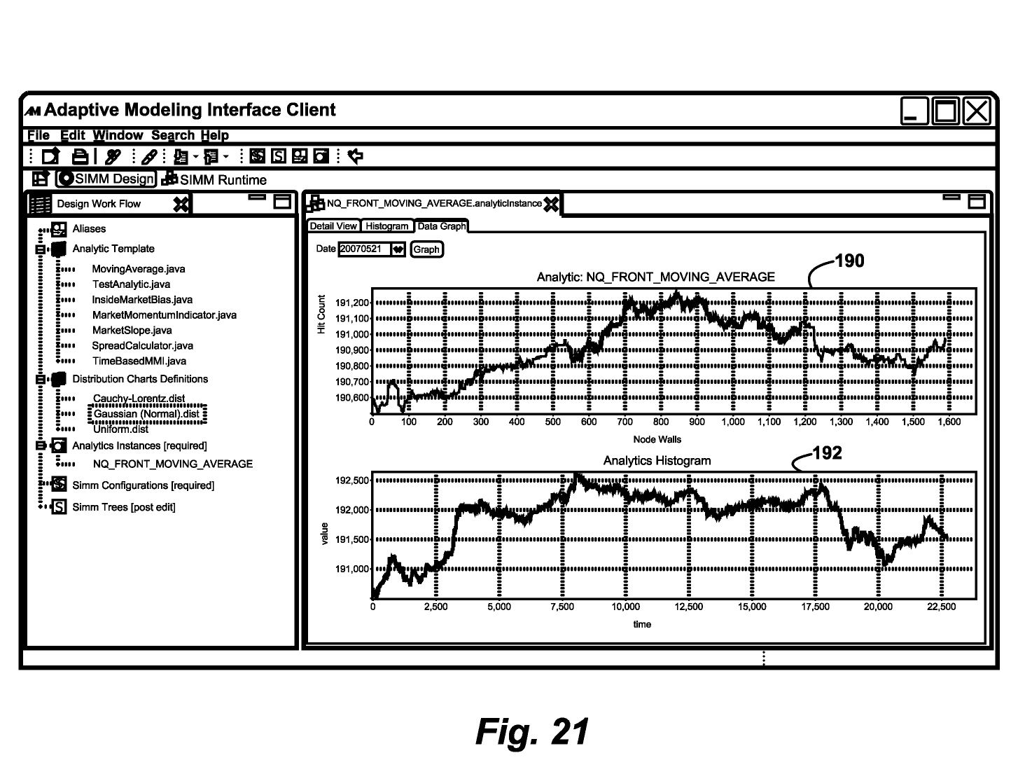

The trader may click on the Data Graph tab 182 to view the analytic values and the scrubbed alias data values in a graphical representation, as shown in FIG. 21. In FIG. 21, an analytic value graph 190 is positioned immediately above an alias graph 192 to provide a meaningful comparison showing how the moving average analytic value (shown in graph 190) changes in response to the underlying raw market data (shown in graph 192).

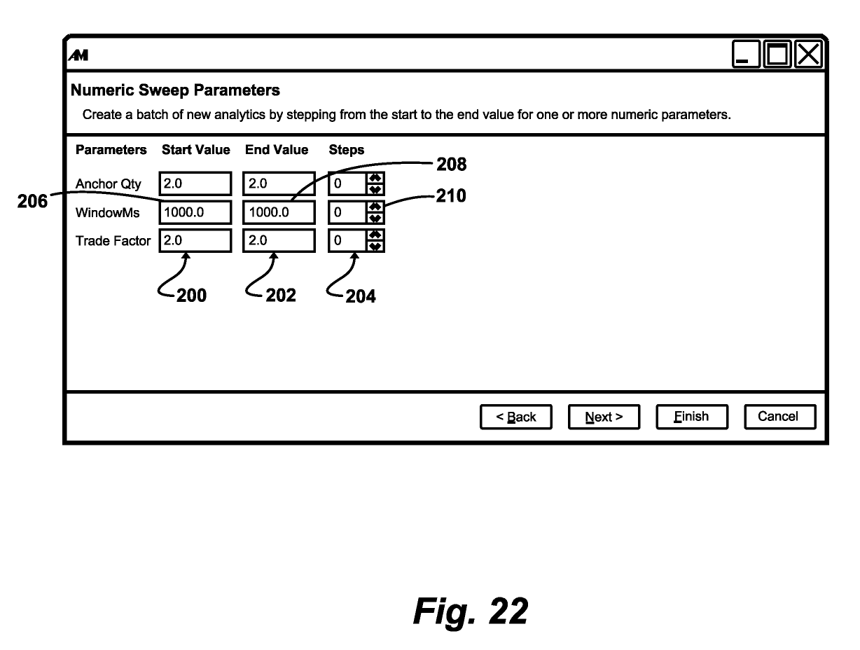

Referring again to FIG. 18, an Analytics Instance Details window 158 shows the analytic instance parameters that have been set by the trader. A Perform Numeric Sweep button 159 enables the trader to vary one or more of the analytic instance parameters so as to perform a sensitivity analysis to see how the analytic values change in response to changes in the parameter settings. When the button 159 is clicked, the trader is presented with the screen shown in FIG. 22.

In FIG. 22, the trader may numerically sweep one or more of the Anchor Qty, WindowMs, and Trade Factor parameters by entering a Start Value in column 200, an End Value in column 202, and the number of steps (sweeping from start to end values) in column 204. For example, if the trader wanted to see how the analytic values change when the WindowMs parameter is swept from 1000 milliseconds to 5000 milliseconds in even 1000 millisecond increments, the trader enters “1000” in window 206 as the Start Value, “5000” in window 208 as the End Value, and “5” in window 210. From these settings, the data analysis engine 14 will run the analytic instance five times with the WindowMs parameter set to 1000 for the first run, 2000 for the second run, 3000 for the third run, 4000 for the fourth run, and 5000 for the fifth run. If the trader chooses to sweep two or more parameters at the same time, then for each setting of one parameter the data analysis engine 14 will sweep every other parameter so that the total number of runs to be made during the sweep increases exponentially.

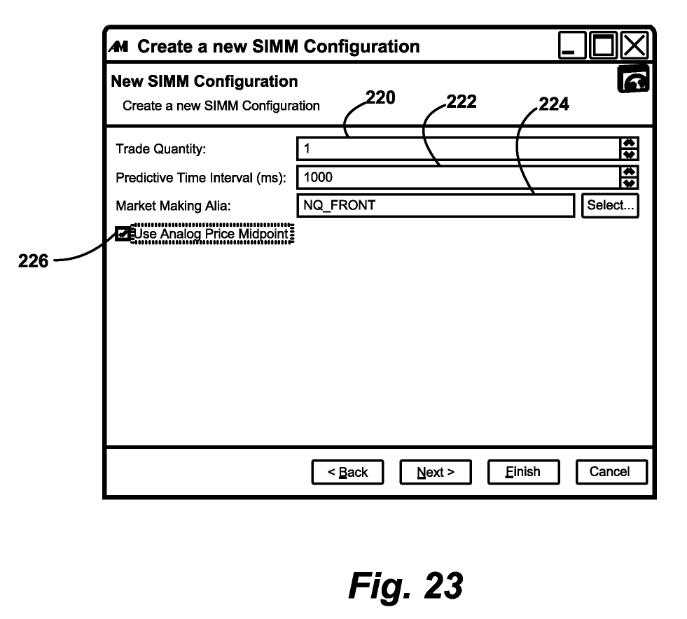

After the trader has obtained a histogram 180 as shown in FIG. 20, the trader is ready to produce a finite state decision tree (also referred to herein as a “SIMM Tree”) on which future trade decisions may be based. The trader initiates the process of building a decision tree by activating the Simm Configurations [required] folder 186 shown in FIG. 20. When folder 186 is activated, the trader is presented with the screen shown in FIG. 23.

In FIG. 23, the trader is asked to select/specify parameters that will be used to determine a Future Trade Price Offset (FTPO) for each node in the histogram 180. In a preferred embodiment, a single FTPO is determined for each node by averaging the individual FTPOs associated with analytic values contained within the node. In Trade Quantity window 220, the trader selects/specifies a quantity that will be used to calculate an average weighted price where the specified quantity represents the number of data points. Here, the trader has entered a Trade Quantity of “1”. Thus, the weighted and non-weighted prices will be the same.

The trader is also required in FIG. 23 to select/specify a Predictive Time Interval in window 222. This parameter sets how far into the future the data analysis engine 14 will look when determining a FTPO. Here, the trader has entered 1000 milliseconds as the Predictive Time Interval in window 222, which instructs the data analysis engine 14 to use the difference between the price of the instrument at the time a trade was made and the price of the instrument 1000 milliseconds later. Market Making Alias window 224 identifies the Alias from which the decision tree will be built. If the Analog Price Midpoint window 226 is checked, the data analysis engine 14 will determine the price of the instrument by calculating the analog midpoint of the price. Otherwise, the data analysis engine 14 will use Last Trade (i.e., the price paid in last trade executed) as the instrument price.

To determine the Analog Price Midpoint, the data analysis engine 14 weights the best bid(s) and best ask(s), adds them together, then divides by the analog quantity for the bid side plus the analog quantity for the ask side. For example, if the current best Bid is 12521 with a volume of 4 units and the current best Ask is 12522 with a volume of 5 units, and assuming an analog quantity of 3 for both the bid and ask has been specified by the trader, then the Analog Price Midpoint will be calculated as follows:

[(12521*3)+(12522*3)]/(3+3)=12521.5

The equation for calculating the Analog Price Midpoint is as follows:

[(Best Bid*Best Bid Qty)+(Best Ask*Best Ask Qty)]/(Best Bid Qty+Best Ask Qty)

If the result is positive, the result will be rounded toward zero. If the result is negative, the result will be rounded from zero. In the above example, since the result is positive, it is rounded down to 12521.

Although a preferred embodiment of the invention employs the option to use either Analog Price Midpoint or Last Trade to calculate a theoretical fair price for the financial instrument, it will be understand that other methodologies may be employed instead, including the following:
Best Ask
Best Bid
Best Bid/Ask Midpoint
Best Bid/Ask Volume Weighted Midpoint
Best Bid/Ask Volume Weighted Midpoint
Best Bid When X Quantity Reached
Best Ask When X Quantity Reached
Best Bid/Ask Midpoint When X Quantity Reached
Analog Market Data Bid for X
Analog Market Data Ask for X
Analog Market Data Bid/Ask Midpoint for X

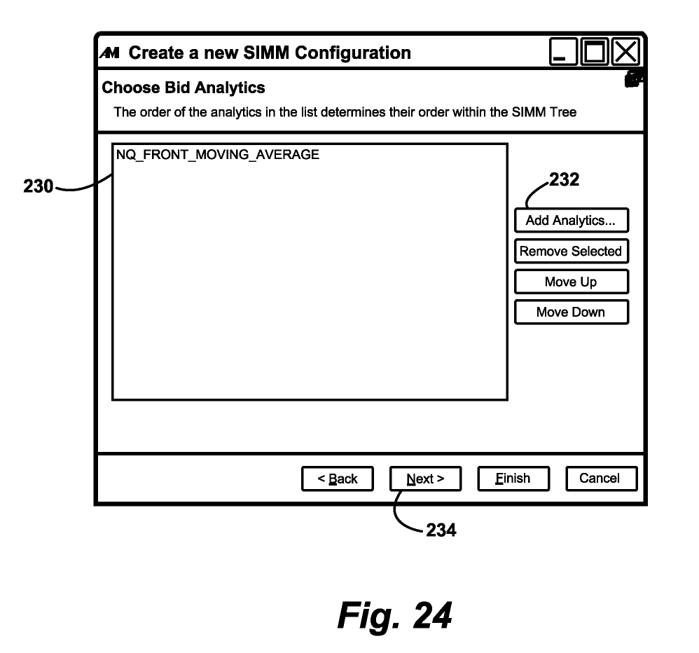

After all parameters in FIG. 23 have been set, the trader clicks the Next button 228 and is presented with the screen shown in FIG. 24.

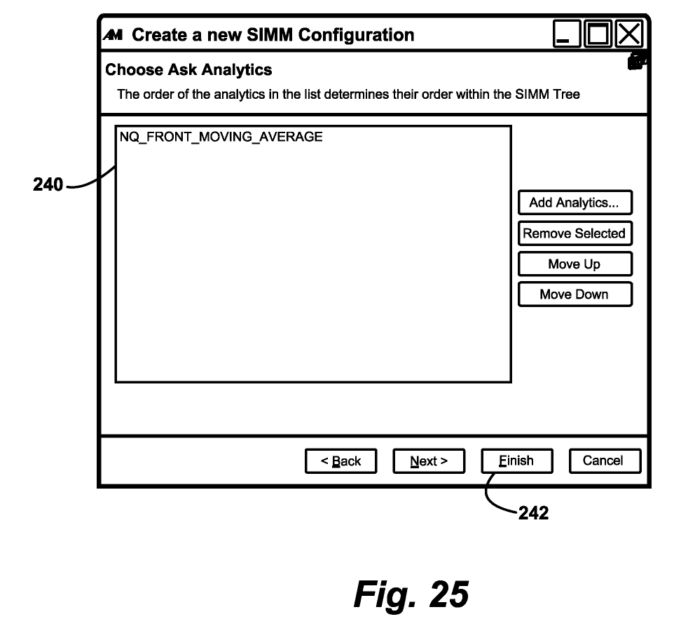

In FIG. 24, the trader specifies/selects in window 230 one or more analytic instances that will be used when the trader wishes to submit Bid orders. Analytic instances that have already been created may be selected by clicking Add Analytics . . . button 232. If multiple analytic instances are entered into window 230, the decision tree will be constructed with multiple levels with one level for each analytic instance. After all desired analytic instances have been entered, the trader clicks the Next button 234 and is presented with the screen shown in FIG. 25.

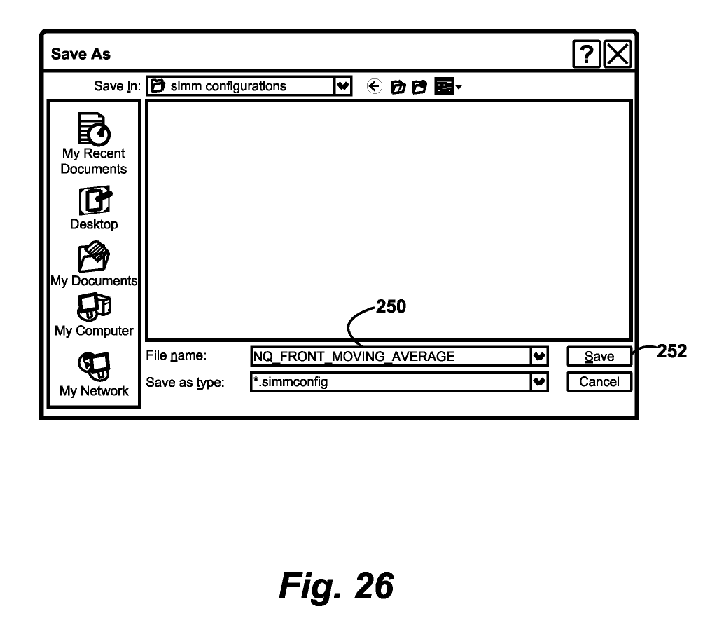

In FIG. 25, the trader likewise enters one or more analytics instances in window 240 that will be used when the trader wishes to submit Ask orders. Like the Bid analytics, tree depth will be determined by the number of analytic instances entered in window 240. Additionally, the analytic instance(s) entered in window 240 may be the same as what was entered for the Bid analytics in FIG. 24, or different. After all analytic instances have been entered, the trader clicks the Finish button 242 and is presented with the screen shown in FIG. 26.

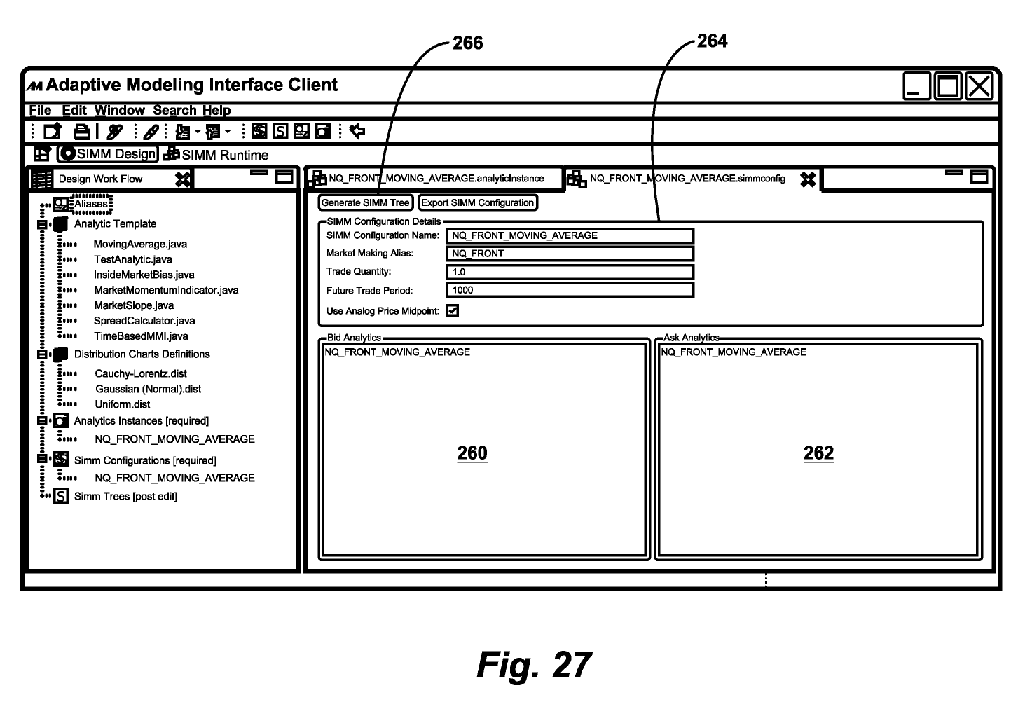

In FIG. 26, the trader specifies a name for the decision tree in File Name window 250. The trader then clicks Save button 252 and the trader is presented with the screen shown in FIG. 27.

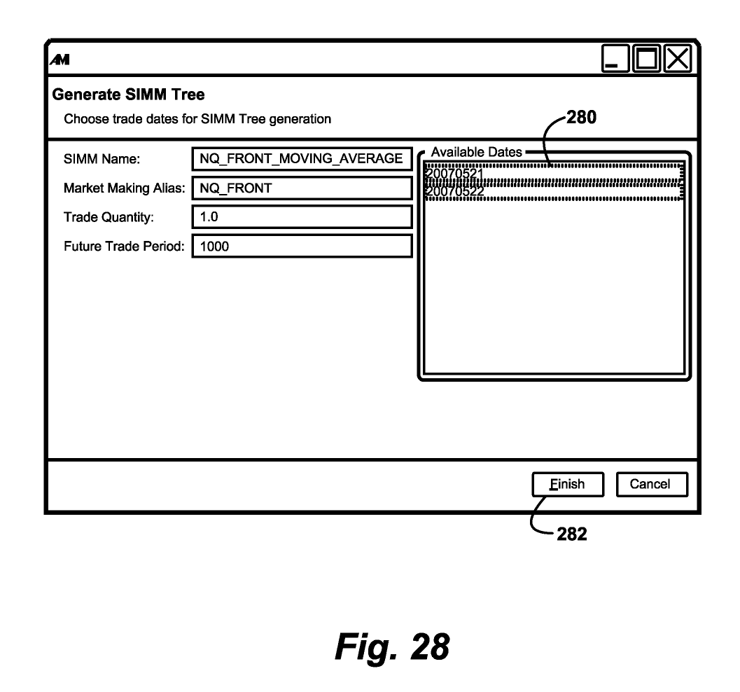

FIG. 27 includes a Bid Analytics window 260 showing each of the analytic instances defined in FIG. 24. An Ask Analytics window 262 similarly shows each the analytic instances defined in FIG. 25. A SIMM Configuration Details window 264 shows the decision name as well as the FTPO parameter settings that were entered in FIG. 23. The trader confirms the information displayed in FIG. 27 then clicks the Generate SIMM Tree button 266 and is presented with the screen shown in FIG. 28.

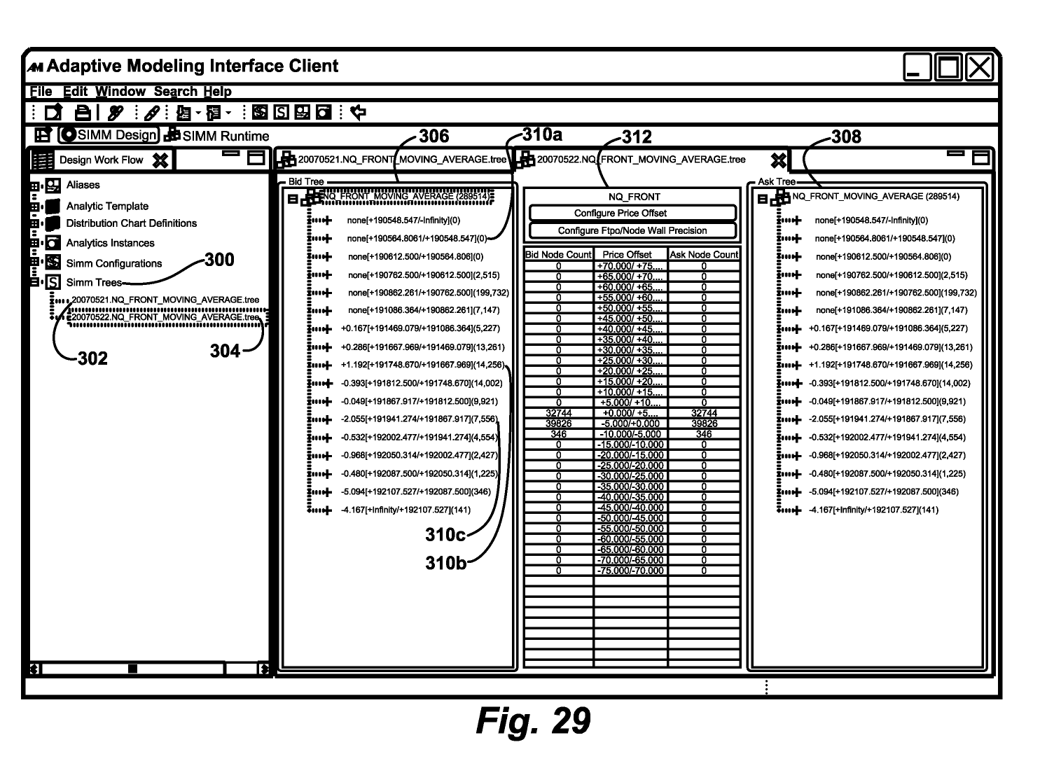

In FIG. 28, the trader is asked to select the trade dates which the decision tree will cover. In Available Dates window 280, the dates of May 21, 2007 and May 22, 2007 have been selected. When Finish button 282 is clicked, the data analysis engine 14 builds the decision tree from the specified parameters. The data analysis engine 14 may build a separate decision tree for each day specified in window 280. Alternatively, the data analysis engine 14 may build a decision tree from multiple or even all days specified in window 280. In this example, for the two dates specified in window 280 (May 21, 2007 and May 22, 2007), a separate decision tree will be built for each day and then combined into a composite decision tree, as more fully described below. When the two decision trees have been built, the decision tree files for each day of the analysis period 302, 304 will appear in the Simm Trees folder 300 shown in FIG. 29.

The decision tree metrics contained within files 302, 304 can be viewed by clicking on the decision tree day files 302, 304. In FIG. 29, for example, the trader has displayed the metrics for the May 22, 2007 decision tree day file 304. Metrics for the May 21, 2007 decision tree day file 302 may be similarly displayed.

The decision tree metrics are displayed in an efficient format that enables the trader to make educated predictions of future price changes to the underlying financial instrument (NASDAQ 100 E-Mini futures contract) based on historical market performance. In essence, the trader studies the decision tree for conditions that exhibit statistically significant historical repetition/trending so that when current market conditions equate to or at least approximate such conditions, the trader may submit trade orders in anticipation that the price of the financial instrument will change in a manner that is reflective of the financial instrument's historical performance.

The screen shown in FIG. 29 includes a view of the Bid side analytics of the decision tree in Bid Tree window 306. The Ask side analytics are displayed in Ask Tree window 308, and the Bid and Ask analytics are shown compositely in window 312. In windows 306 and 308, the metrics for each node of the decision tree are shown on a separate line (such as lines 310a, 310b and 310c) and include information in the following format:

FTPO [Maximum Analytic Value/Minimum Analytic Value] (No. of Hits)

For example, the metrics for node 308b include an FTPO (preferably calculated as an average FTPO for the node) of “+1.192”, a Maximum Analytic Value of “191748.670”, a Minimum Analytic Value of “191667.969”, and “14,256” hits (i.e., occurrences where an analytic value falls within the Max and Min analytic values set for the node.

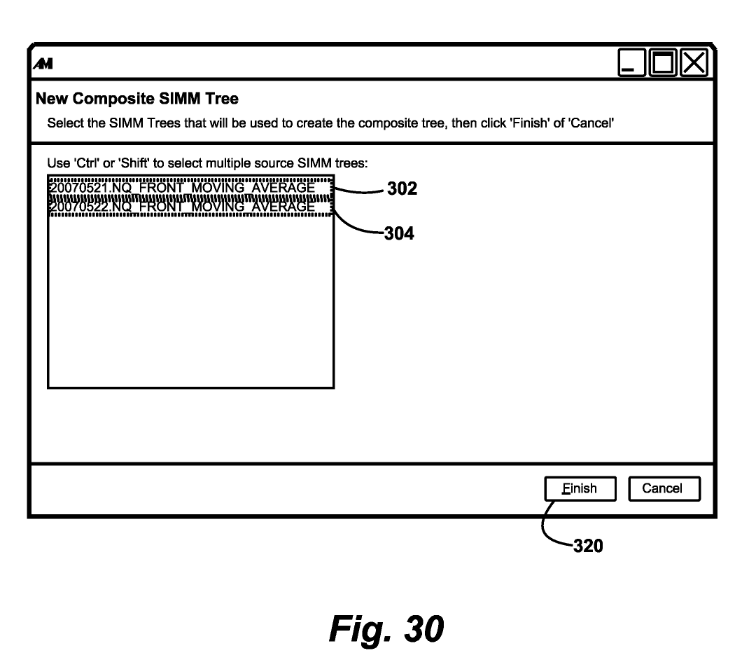

The two decision tree day files 302, 304 are now ready to be combined into a composite decision tree covering both of the May 21, 2007 and May 22, 2007 analysis dates. The trader initiates the process of building the composite decision tree by hovering over the Simm Trees folder 300 with an onscreen pointer while right clicking. A pop-up window (not shown) is displayed adjacent folder 300 with a New Composite Tree option, the trader clicks the New Composite Tree option, and the trader is presented with the screen shown in FIG. 30.

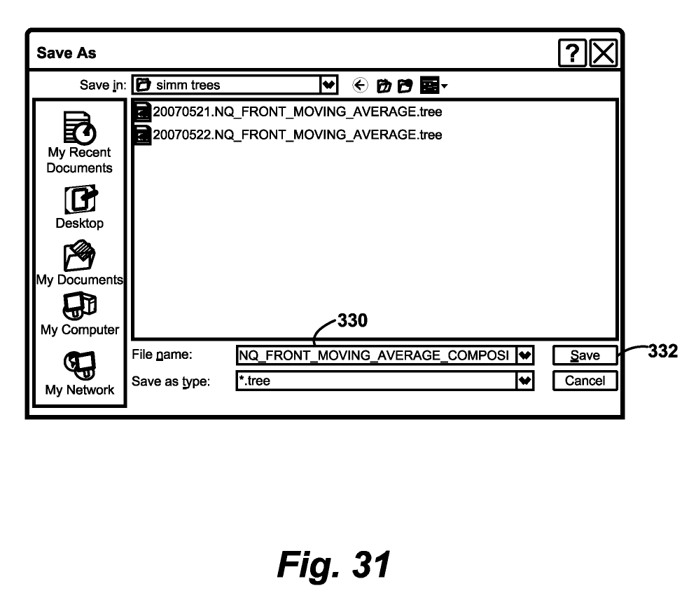

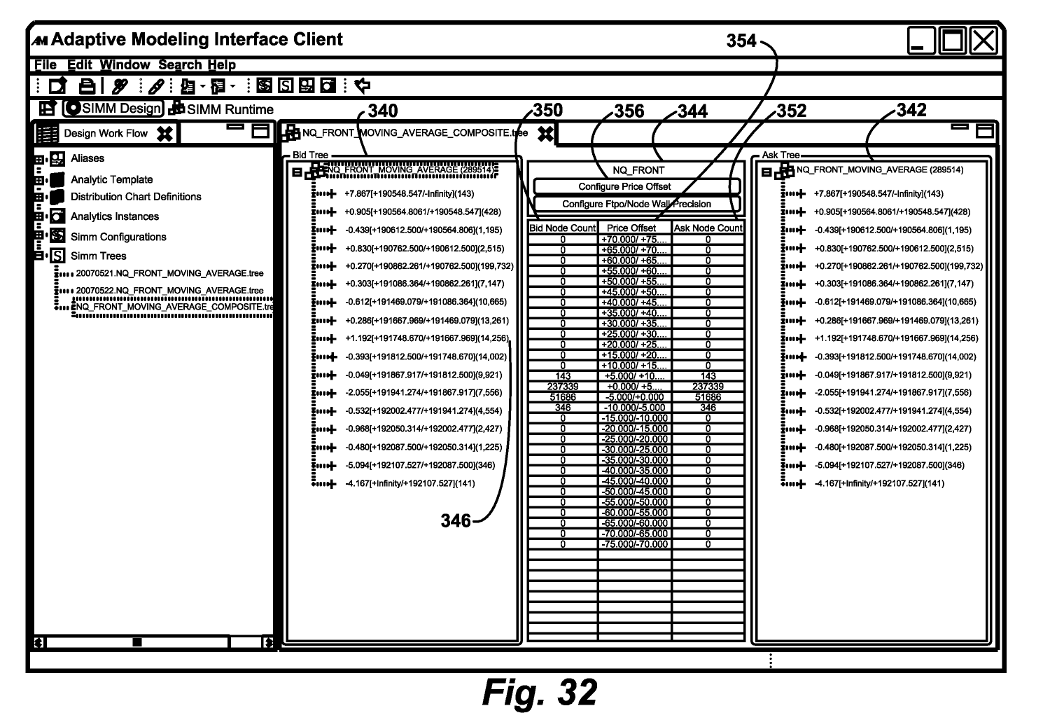

In FIG. 30, the trader selects both of the displayed decision tree day files 302, 304 and clicks the Finish button 320. The trader is then presented with the screen shown in FIG. 31. A file name for the composite decision tree is entered into File Name window 330, the trader clicks the Save button 332 to save the composite tree, and the trader is presented with the screen shown in FIG. 32.

FIG. 32 includes a view of the Bid side analytics of the composite decision tree in Bid Tree window 340. The Ask side analytics are displayed in Ask Tree window 342, and the Bid and Ask analytics are shown compositely in window 344. The trader may identify favorable trading conditions by studying the analytics shown in the composite decision tree. For example, when current market data results in a Moving Average analytic value that falls within node 346, the trader may wish to submit one or more Buy orders for the NASDAQ 100 E-Mini instrument since the composite decision tree shows that, on average, the price of the instrument will increase by 1.192 within 1000 milliseconds (see Predictive Time Interval parameter 222 of FIG. 23). Of course, in submitting such trade order(s), the trader will need to determine for himself/herself that the information provided in the decision tree, and particularly the information contained in node 346, is a sufficiently significant indicator of how the instrument's price will change in the future.

Bid and Ask analytics are shown compositely in FIG. 32 at window 344 with Bid analytics shown in Bid Node Count column 350, Ask analytics shown in Ask Node Count column 352, and FTPO values shown in Price Offset column 354. This composite view of the decision tree shows that for the Bid analytics, there were 143 hits with an FTPO between +5.00 to +10.000, 237,339 hits with an FTPO between +0.000 to +5.000, 51,686 hits with an FTPO between −5.000 to +0.000, and 346 hits with an FTPO between −10.000 and −5.000. While these results provide a level of insight into where the price of the financial instrument typically moves in response to certain market conditions, the trader may wish to obtain additional details on the analytic results. For example, window 344 shows that the price of the instrument dropped by an amount in the range of +0.000 to +5.000 a total of 237,339 times. However, this view of the analytic results does not show the trader how many of those hits involve a change of 0. While a trader might assume an even distribution of the 237,339 hits over the +0.000 to +5.000 FTPO range, such an assumption would carry some risk since it is also possible that the distribution is significantly different than an even distribution. In fact, it is entirely possible that all 39,826 of the hits have an associated FTPO of 0.

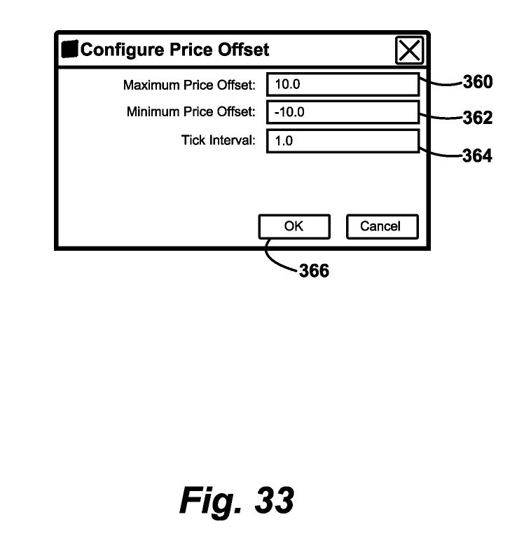

To accommodate a trader's need for a more detailed view of the decision tree metrics, the granularity of the displayed decision tree may be adjusted by the trader. To do so, the trader clicks on the Configure Price Offset button 356 and is presented with the Price Offset Adjustment screen shown in FIG. 33.

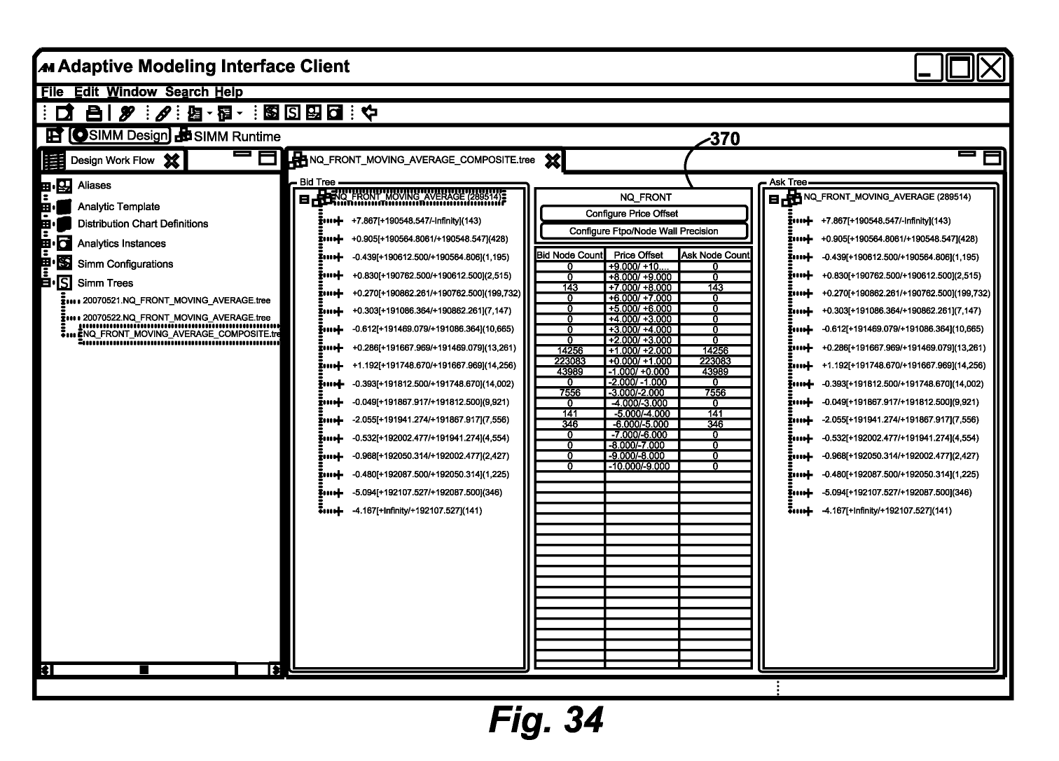

In FIG. 33, the trader may adjust the distribution of hits in the composite decision tree window 344 by changing the Max and Min FTPO values and/or the tick interval displayed in the Price Offset column 354. In FIG. 32, the Maximum FTPO value in column 354 is +70.000 and the Minimum FTPO value is −70.000. Since the trader knows from FIG. 32 that all FTPO values lie between a Maximum of +10.000 and a Minimum of −10.000, the trader has decided to set the Maximum FTPO value at −10.0 in Maximum Price Offset window 360, the Minimum FTPO value at −10.0 in Minimum Price Offset window 362, and a tick interval of 1.0 in Tick Interval window 364. The trader then clicks OK button 366, data analysis engine 14 redistributes the analytics in the composite decision tree window 344 of FIG. 32, and a new decision tree is presented to the trader as shown in FIG. 34.

As can be seen in the decision tree window 370 of FIG. 34, the trader can now view the decision tree analytics with a greater level of detail and granularity. For example, the trader can now see that of the 237,339 hits falling within the +0.000 to +5.000 FTPO range, the vast majority of those hits (223,083) fall within an FTPO range of +0.000 to +1.000, and there are no hits with an FTPO above +2.000. This additional information helps the trader to make more informed trade decisions.

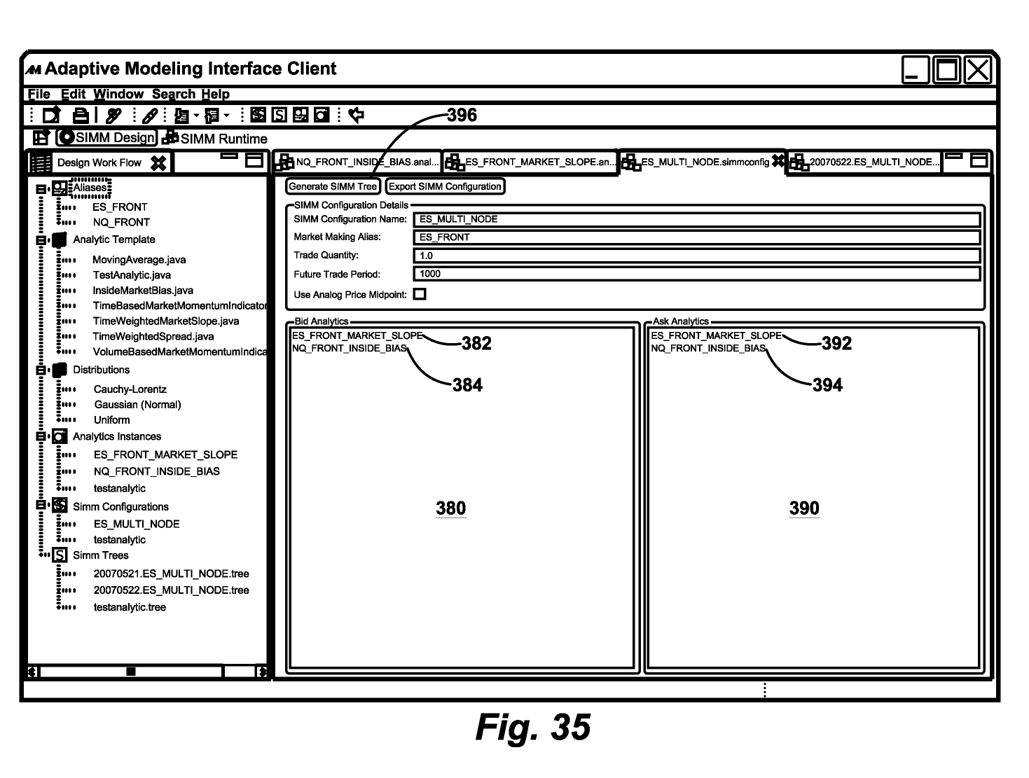

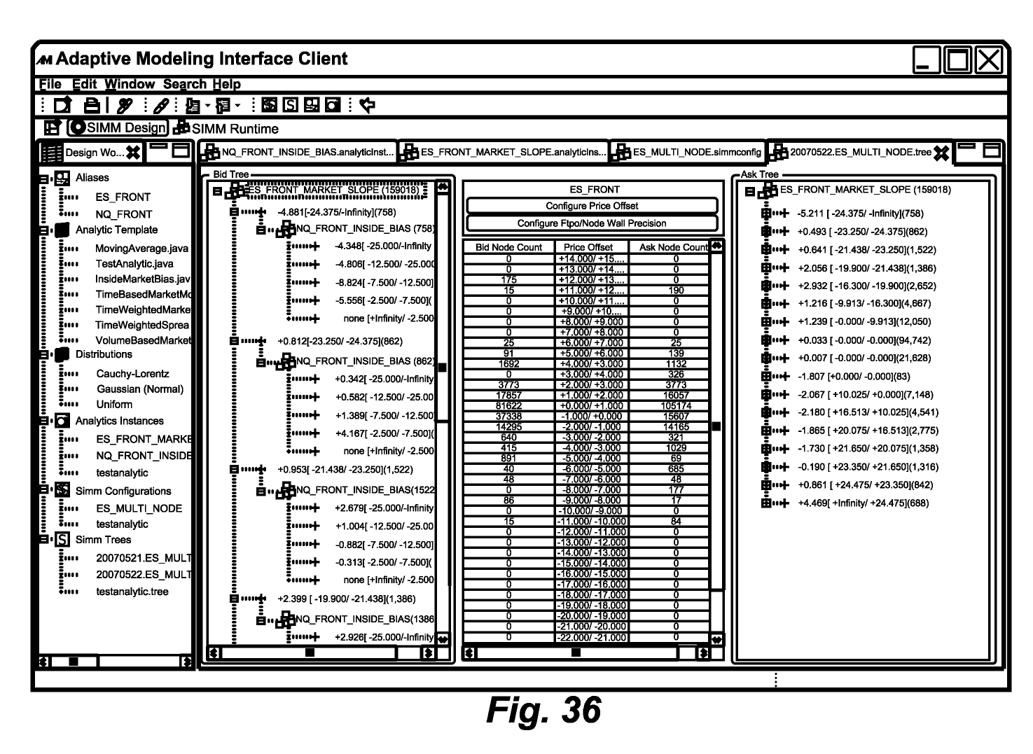

As previously described, if multiple analytic instances are entered into window 230 of FIG. 24, the decision tree will be constructed with multiple levels with one level for each analytic instance. FIG. 35 includes an exemplary screen that shows two analytic instances for both the bid analytics and the ask analytics. More particularly, Bid Analytics window 380 shows a first bid analytic instance titled ES_FRONT_MARKET_SLOPE 382 and a second analytic instance titled NQ_FRONT_INSIDE_BIAS 384. And Ask Analytics window 390 shows first and second ask analytic instances 392, 394 of the same title. The parameters and information displayed in FIG. 35 are stored in a decision tree configuration file for later use when trading the instrument based on the decision tree metrics. When the trader clicks the Generate SIMM Tree button 396, the trader is presented with the multi-level decision tree metrics shown in FIG. 36.

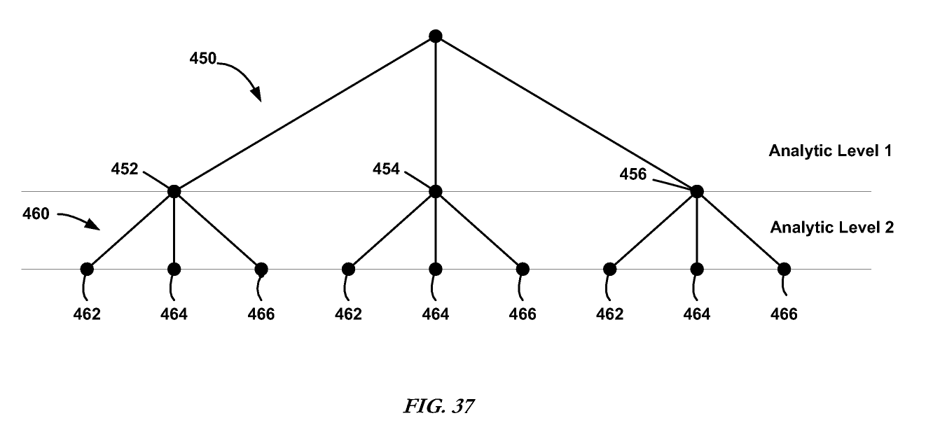

A decision tree with multiple analytic levels can be graphically represented by a tree structure as shown in FIG. 37. The general decision tree structure of FIG. 37 includes a first analytic level 450 with three nodes 452, 454 and 456, and a second analytic level 460 with three nodes 462, 464 and 466. To provide a basic example fitting the particular tree structure shown in FIG. 27, assume a trader believes that prices of an instrument tend to trend consistently up or down in the overall time window between the hours of 10-11 AM each day. The trader might employ a combination of two analytics where Analytic 1 (450) is the “time of day” which, when a market update is received, produces an analytic value of “0” if the time stamp is less than 10 AM, a “1” when the time stamp is between the hours of 10AM and 11 AM, inclusive, and a “2” when the time stamp is greater than 11 AM. In this example, the node walls for the “time of day” analytic could be set to 0.5 and 1.5 so that an analytic value of “0” falls in node 452, an analytic value of “1” falls in node 454, and an analytic value of “2” falls in node 456. For Analytic 2 (460), the trader might employ a “simple time window market slope” which produces an analytic value of “−1” when the change in instrument price over a period of time is less than zero, a “0” when the change in instrument price over a period of time is equal to zero, and a “1” if the change in instrument price over a period of time is greater than zero. For this analytic, the node walls could be set to −0.5 and 0.5 so that an analytic value of “−1” falls in node 462, an analytic value of “0” falls in node 464, and an analytic value of “1” falls in node 466. By combining the two analytics as levels, the trader's strategy to determine the likely future trade price can be implemented in the form of a decision tree. A likely future trade price offset can be determined for each node by running the analytics on historical data and averaging the historical future trade price offset for each analytic output value, grouped by tree node.

When using the decision tree to trade in real time, a trader may decide to generate one or more trade orders for trading the financial instrument at one or more electronic exchanges at a trade price that is determined based on the future price indicator associated with a node of the decision tree to which a current analytic value (produced in real time) relates. The determinative future price indicator may be for either analytic level 450, 460, or both analytic levels 450, 460, but is preferably the future price indicator provided by the lower most analytic level of the predictive model. Trade orders may be generated and submitted by the trader based on commands entered by the trader, or trade orders may be generated and submitted automatically by an automated trading platform that has been configured for automated/programmatic trading based on where current analytic values fall in the decision tree 450.

Thus, it will be appreciated that construction of a predictive model representing assumed price behavior of financial instruments as described herein enables traders to implement unique trading strategies using multi-variants, and to thereby identify favorable trading opportunities as such opportunities arise in real time.

Implementation of a predictive model of assumed price behavior (such as a decision tree as described herein) of a financial instrument for use in generating one or more trade orders for trading the financial instrument at one or more electronic exchanges will now be described in greater detail. For purposes of the description contained herein, the term “electronic exchange” shall be interpreted to encompass ECNs, brokers, clearing firms, and other entities where trade orders may be submitted.

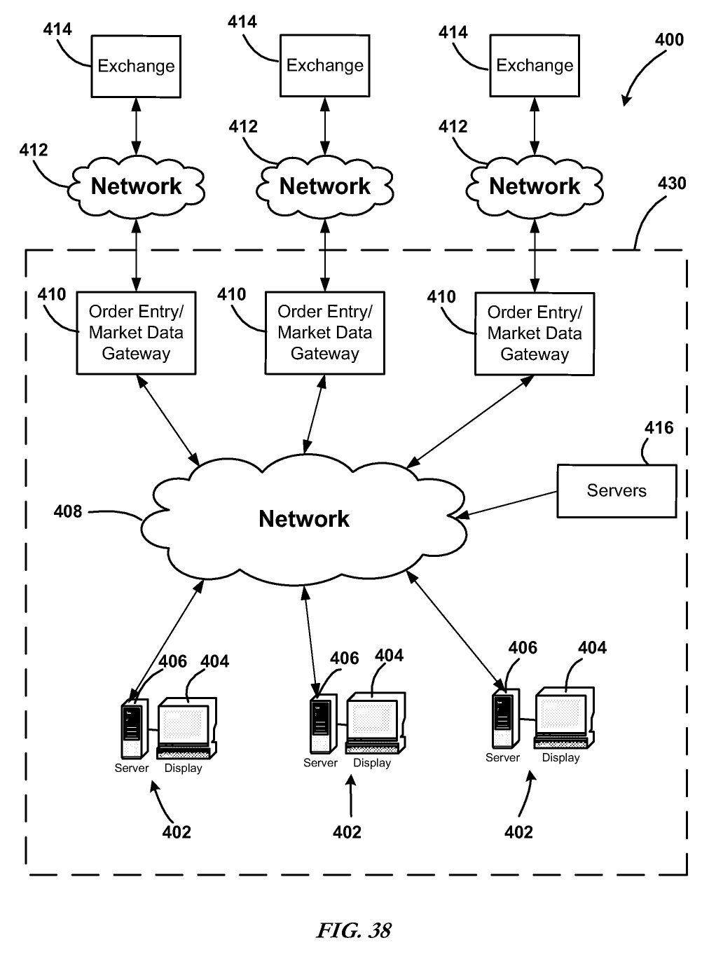

FIG. 38 shows a computer-implemented apparatus 400 suitable for trading a financial instrument based on a model of assumed price behavior of the financial instrument. The apparatus 400 includes one or more trader/client terminals 402 having a graphical user display and human interaction device 404 (such as a computer monitor with keyboard and/or mouse) and a client processing device 406, which may be a dedicated client computer for each terminal 402 as shown in FIG. 38 or a single computing device networked to each of the trader terminals 402. Each trader terminal 402 is configured for electronic communication with an electronic exchange 414 by way of a communication network 408, which may be either a totally wired network or one that is configured to enable at least some components to communicate wirelessly. Trade orders submitted from a trader terminal 402 are routed through network 408 where order entry gateways and market data gateways 410 for each exchange 414 receive the trade orders and place them in the proper electronic format according to protocol required by the particular exchange 414. Order entry/market data gateways 410 may be optionally installed in separate hardware, such as one or more servers 416 in communication with network 408, or gateways 410 may be installed in the trader terminal 402. The trader terminals 402, network 408, servers 416 and order entry and market data gateways 410 are typically elements within the trader's system 430, while network 412 and exchanges 414 are external to the trader's system. Trade orders are then received by an exchange 414 via a communication network 412. Optionally, a live market data feed 416 is provided to enable traders to view and/or utilize live market data as needed to implement a trader's strategy.

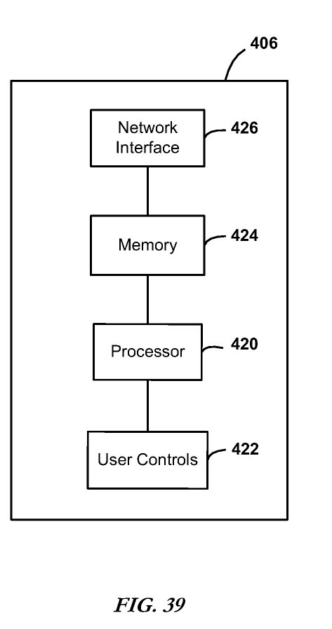

FIG. 39 shows the basic hardware associated with each of the client processing devices 406 shown in FIG. 38. The device 406 includes a programmable electronic processing device 420 (such as a dual quad core Xeon™ E-5420 processing device provided by Intel™) in communication with the display device 404, a user input device 422 (such as a computer mouse with buttons and/or a computer keyboard), and a network interface 426 for sending and receiving communications from network 408. The client processing device 406 is programmed to utilize the analytics of a predictive model of the type described herein and generate one or more trade orders when the predictive model indicates that trading conditions are favorable. Programming for processing device 406 may be stored in electronic memory 424, which may include RAM (random access memory), ROM (read only memory), or other suitable form of memory.

In operation, the apparatus 400 obtains a future price indicator for the financial instrument to be traded by comparing a current analytic value representing current price behavior of the financial instrument to analytic values contained within a predictive model having one or more analytic levels representing assumed price behavior of the financial instrument. In a preferred embodiment, one or more trade orders are automatically/programmatically (i.e., according to programmed trading criteria) generated for trading the financial instrument at an electronic exchange 414 via the communication network 408 either immediately or when the future price indicator meets the trader's criteria for trading. Alternatively, trade orders may be discretely generated by the trader when the future price indicator meets the trader's criteria for trading at a favorable price level as indicated by the future trade price offset for the tree node that matches the current analytic value. Trade orders that may be generated include resting orders that are submitted to an exchange and rest on an order book for the financial instrument until filled at the exchange or cancelled by the trader, or re-priced in response to a change in market conditions or analytic output. Snipe orders may also be generated and submitted to an exchange only while a future price indicator meets the trader's criteria for trading. Both resting and snipe orders may be either “one-way” or “round-trip”, and both resting and snipe orders may be static (rests without modification until filled) or, preferably, dynamic (if not filled, will be modified based on re-pricing as market updates are received). Resting trade orders may be modified by canceling the order and/or replacing the order with a new order at a different price level. The specifics of how this is accomplished in a preferred embodiment will now be described in greater detail.

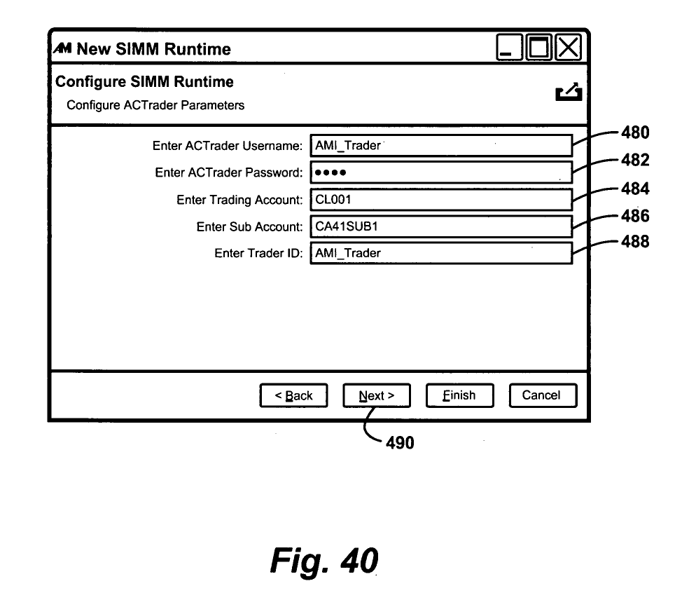

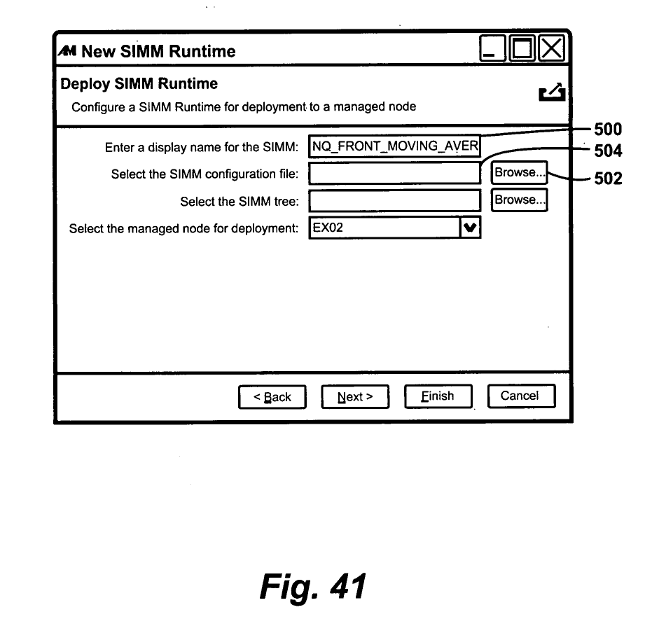

FIG. 40 shows a screenshot of an initial screen that is presented when the trader launches a trading session with a trading platform, such as the ACTrader™ trading platform, which is available for license from TradeHelm, Inc. of Tulsa, Okla. In FIG. 40, the trader enters a valid username in field 480, a valid password in field 482, a valid trading account in field 484, a valid sub account in field 486, and a valid trader ID in field 488. The trader then clicks Next button 490 and is taken to the screen shown in FIG. 41.

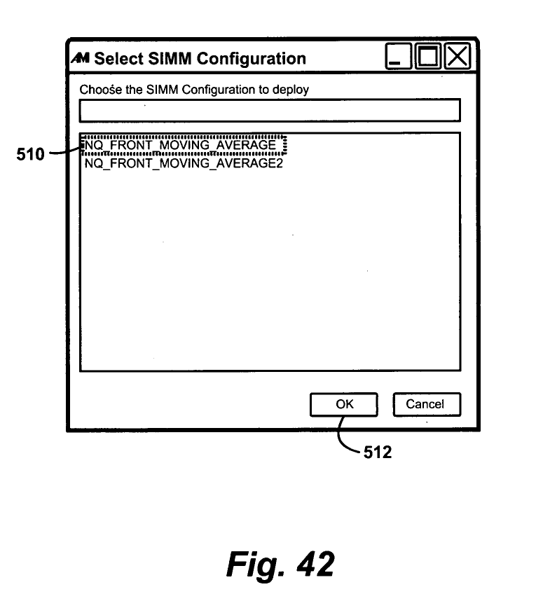

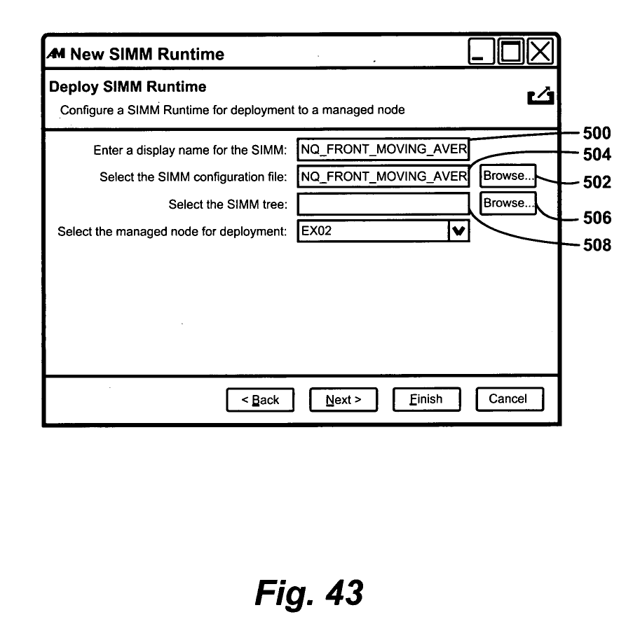

In FIG. 41, the trader enters a display name for the instance of the automated trading session in field 500. Here, the trader has entered a name—NQ_FRONT_MOVING_AVERAGE—that is descriptive of the analytics that make up the decision tree on which trading decisions will be based. The trader then selects a decision tree configuration file of the type described above in connection with FIG. 35 by clicking Browse button 502, which presents the trader with the screen shown in FIG. 42. In FIG. 42, the trader has selected configuration file 510 titled “NQ_FRONT_MOVING_AVERAGE”. When the trader clicks OK button 512, the selected decision tree configuration file 510 is displayed in the configuration file field 504 of FIG. 41, as shown in FIG. 43.

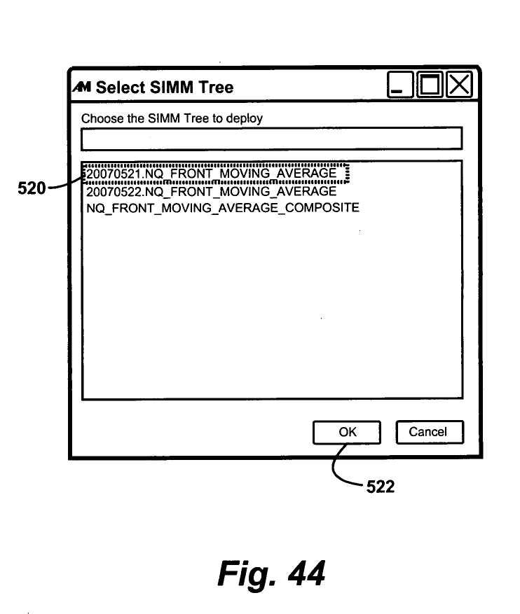

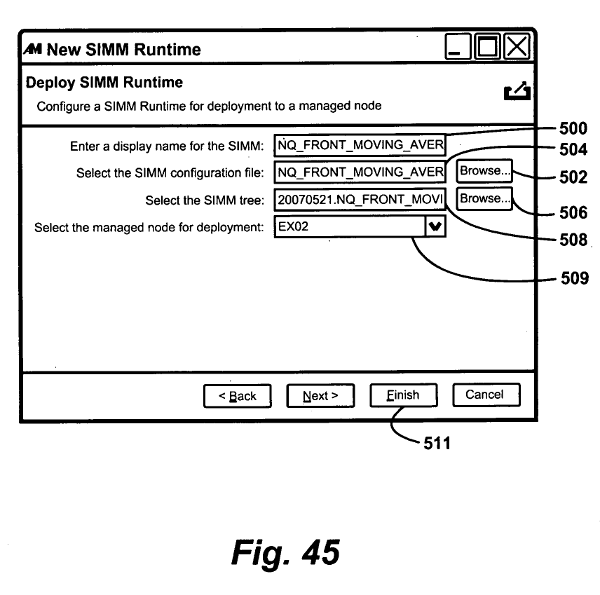

With continued reference to FIG. 43, the trader also selects a decision tree file by clicking Browse button 506, which presents the trader with the screen shown in FIG. 44. In FIG. 44, the trader has selected decision tree file 520 titled “20070521.NQ_FRONT_MOVING_AVERAGE”. When the trader clicks OK button 522, the selected decision tree file 520 is displayed in the decision tree file field 508 of FIG. 43, as shown in FIG. 45. The trader then selects or specifies at field 509 a server (such as server EX02) on which the trading session will be deployed. Server EX02 may be processing device 406 (FIG. 38), one of servers416, or any other suitable machine. Calculating current analytic values (representing current price behavior of the financial instrument to be traded) in real time and relating them to analytic values contained within the decision tree requires processing power. By allowing the trader to specify a particular machine onto which the trading session will be deployed, the trader can distribute the processing load across hardware and processing power to perform the necessary math quickly, which in turn enables the trader to advantageously make trade decisions more quickly.

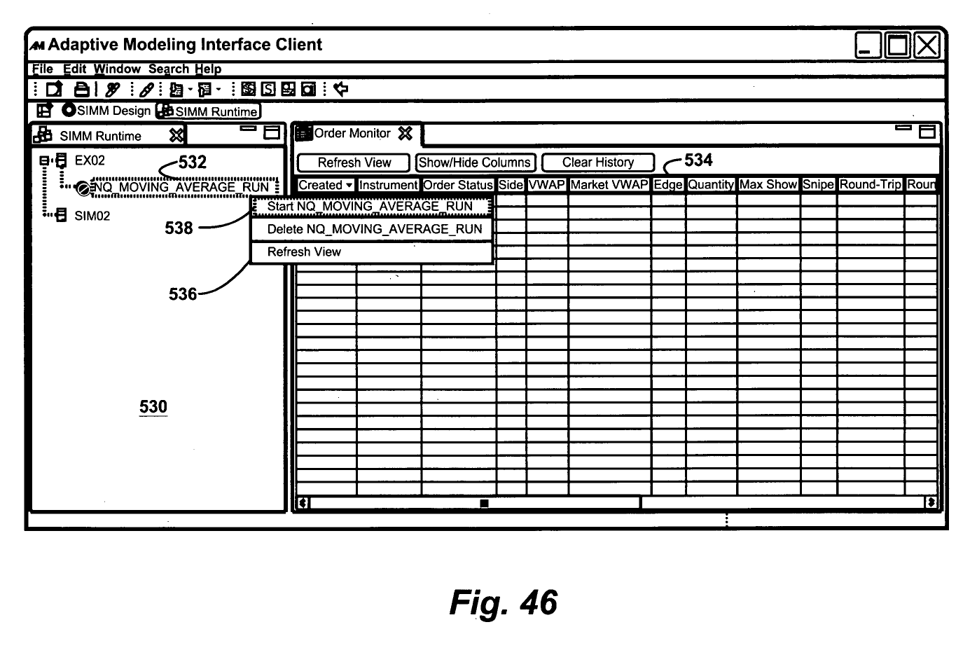

When the trader clicks Finish button 511, the trader is presented with the screen shown in FIG. 46, which shows in window 530 deployment of a trading session 532 titled “NQ_MOVING_AVERAGE_RUN” onto server EX02 (as specified in field 509 of FIG. 45). The screen of FIG. 46 also includes an order monitor window 534 for displaying the particulars (including order information and statistics) of trade orders submitted automatically/programmatically during the trading session.

To launch the trading session 532, the trader activates the trading session 532 (such as by right clicking the trading session 532) and pop-up window 536 appears. The trader then selects the “Start NQ_MOVING_AVERAGE_RUN” option 538 to launch the trading session 532.

When the trading session 532 is launched, the designated server EX02 begins calculating current analytic values in real time for each analytic level of the decision tree. For example, if the decision tree designated in field 508 of FIG. 45 were composed of two analytic levels with each analytic level having three nodes as generally illustrated in FIG. 37, then a current analytic value would be produced for each analytic level 450, 460 in real time. As previously discussed, an analytic value may be any number produced in essentially any manner that is representative of assumed price behavior of the financial instrument. If market data analysis is employed, as discussed above, to populate the decision tree, a trader may find it desirable to employ the same analysis to live market data received via data feed 416 to produce current analytic values. Each of the current analytic values is related to one of the nodes of a corresponding analytic level of the predictive model, and this information is used by the algorithm software to automatically/programmatically generate one or more trade orders for trading the financial instrument at an electronic exchange when the future price indicator associated with a node to which a current analytic value relates meets the trader's criteria for trading.

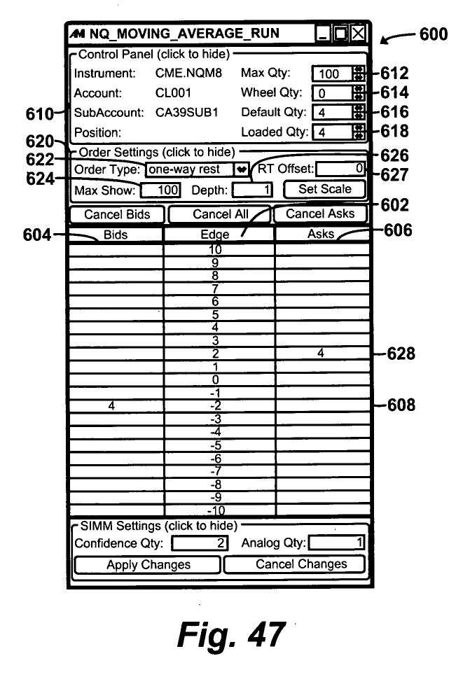

As previously described, a trader may generate and submit trader orders discretely based on where current analytic values fall in the decision tree. The apparatus 400 may also be configured to generate and submit trade orders automatically/programmatically when current analytics meet the trader's specified criteria for trading. On-screen graphical control interfaces and graphical displays may be employed to assist the trader in generating requests for the system to automatically place trade orders based on the decision tree analytics, which require the trader's criteria for trading. FIG. 47 shows one embodiment of such a graphical control interface 600 that can be used to automatically generate trade orders based on a trader designated “edge” value representing an amount a trader wishes to make on a trade of the financial instrument. The edge value can be a measure of the financial instrument's tick size, including fractionals thereof. Alternatively, the edge value can be a measure of a currency amount (such as US dollars), or the edge value can be measured in points. Preferably, the edge value will be measured in the same units as that of the future price indicator. For the exemplary embodiment of FIG. 47, the edge values are measured in ticks.

Interface 600 includes a central Edge column 602, a Bids column 604 and an Asks column 606. The interface 600 is configured to enable a trader to define a trader's criteria for trading by simply clicking a mouse button with the mouse pointer positioned at a desired edge value after configuring the order settings at window 620. More specifically, to place one or more Bid orders at an edge value of “−2”, the trader positions the mouse pointer at edge value row 608 and clicks the left mouse button. To place an Ask order, the trader right clicks at the desired edge value. A control panel 610 is provided to enable the trader to set a maximum trade quantity at field 612, a trade quantity change amount for each rotational tick of the mouse scroll wheel at field 614, a default trade quantity at field 616, and a loaded trade quantity at field 618, which is the quantity that will be placed at the selected edge level when the trader left or right clicks. An Order Settings window 620 enables the trader to set order type at field 622, Max Show at field 624, and Depth of Book at field 626.

For the interface 600 shown in FIG. 47, the trader has set Order Type to “One-Way Rest” in field 622 and the default trade quantity is set to “4”. The trader has left clicked at edge value level “−2” (row 608), which starts processes that attempt to work trade orders that meet this criteria based on predictions obtained with the predictive model. Left clicking at row 608 places a value of “4” in the Bids column 604 of row 608 to indicate that the trader wishes to buy 4 units of the instrument (NASDAQ ES Mini-NQM8—at the CME) at a two tick advantage over the predicted future trade price. Trading criteria includes not only the edge value specified, but also the type of order specified in field 622. For a snipe order, a trade order will be submitted only while the future price indicator predicts a future price change greater than or equal to the inverse of the specified edge value. The snipe order may rest, execute immediately, or change price (including order cancellation) as new current analytic values are generated based on market condition changes and re-pricing of the instrument occurs. For resting orders, a trade order will be submitted immediately at a price that is −X number of ticks from the predicted future price where “−X” is the inverse of the specified edge value, and the trade order will rest (both initially and after re-pricing) at −X ticks from the current future price indicator until filled, manually cancelled, or automatically re-priced. In FIG. 47, the trader has also right clicked at edge value level “2” (edge value row 628), which places a value of “4” in the Asks column 606 at row 628 to indicate that the trader wishes to sell 4 units of the instrument at an edge value of “2” from the predicted price. Thus, with two simple mouse clicks the trader has initiated automated processing of orders by the trading system (such as the ACTrader™ trading system).

For round trip orders, a first trade order is generated for trading the financial instrument at the future trade price (as indicated by the future price indicator) plus the designated edge value. If no edge value is being used by the trader, then the first leg of the round trip order is priced at the predicted future price. The second leg of the round trip order will be priced at the fill price of the first leg minus the designated edge value. To help ensure the second leg of the order gets filled before the market moves away, the trader may designate a round trip/hedge offset at field 627 of FIG. 47. The hedge offset value in field 627 is added to the price calculation for the second leg of the round trip order and has the effect of increasing the likelihood of getting the second leg filled. The negative effect of using a hedge offset, however, is that is acts to reduce the amount of profit the trader will make.

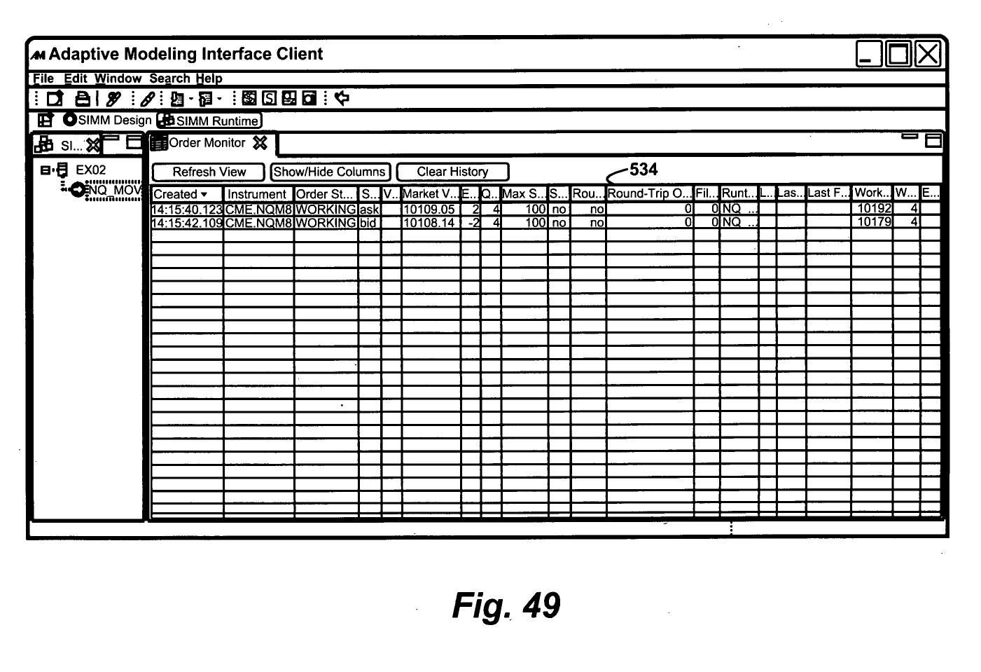

The particulars of all trade orders submitted during the trading session can be viewed in the Order Monitor window 534 of FIG. 46, as shown in FIG. 49. The resting Bid order represented in row 608 will not execute until a seller of the instrument sells to the trader at a price level that is 2 ticks (or dollars or points) below a current predicted future price (as predicted by any one or more analytic levels of the decision tree, depending on the particular configuration desired by the trader). Thus, the trader hopes to buy 2 ticks lower than the predicted future price. Likewise, the resting Ask order represented in row 628 will not execute until a buyer of the instrument buys from the trader at a price level that is 2 ticks (or dollars or points) above a current predicted future trade price. Thus, the trader hopes to sell 2 ticks higher than the predicted future price. When used in combination, these two orders are intended to achieve a total of 4 ticks difference between Buy and Sell, which represents the trader's anticipated profit.

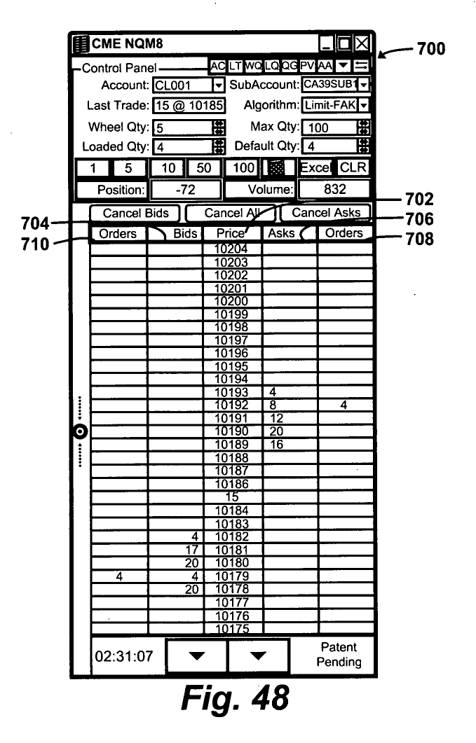

Placement of the Bid and Ask orders shown in FIG. 47 on the exchange book can be monitored by the trader with the use of a graphical interface 700 of a type shown in FIG. 48, which shows existing market Bids and Asks in the marketplace in columns 704 and 706, respectively, at the prices indicated in column 702. The working Ask order with a quantity of 4 shown in row 628 of FIG. 47 can be seen in column 708 of FIG. 48, and the working Bid order with a quantity of 4 shown in row 608 of FIG. 47 can be seen in column 710 of FIG. 48. The graphical interface 700 of FIG. 48 enables the trader to track the quantities and prices of the trader's working orders and, if necessary, automatically cancel or adjust the orders as needed during re-pricing based on changing market conditions or analytic outputs.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A computer-implemented method for trading a financial instrument based on a model of assumed price behavior of the financial instrument, said method comprising:
providing a predictive model representing assumed price behavior of a financial instrument, said predictive model including one or more analytic levels, each of said one or more analytic levels having a plurality of analytic values divided into two or more nodes wherein each node is associated with a future price indicator that represents an assumed future price of the financial instrument;
producing a current analytic value in real time for each of said one or more analytic levels;
relating each current analytic value to one of the nodes of a corresponding analytic level of the predictive model; and
generating one or more trade orders for trading the financial instrument at one or more electronic exchanges at a trade price that is determined based on the future price indicator associated with a node to which the current analytic value relates.

2. The method of claim 1 wherein said one or more trade orders are executed when for each analytic level of the predictive model, the future price indicator of a node to which the respective current analytic value relates meets a trader's criteria for trading.

3. The method of claim 1 wherein said future price indicator is measured in units of the financial instrument's tick size.

4. The method of claim 1 wherein said future price indicator is measured in units of a currency amount.

5. The method of claim 1 wherein said future price indicator is a price offset representing a difference between a current price of the financial instrument and a price of the financial instrument at a later time.

6. The method of claim 5 wherein said later time is 2,000 milliseconds.

7. The method of claim 1 wherein said generating step further includes submitting an order to an exchange that rests on an order book for the financial instrument until the trader's criteria for trading is met.

8. The method of claim 1, further comprising
re-calculating the trade price based on an updated current analytic value and corresponding future price indicator as market conditions change; and
modifying the trade price of at least one of said one or more trade orders when re-pricing results in a new future price indicator.

9. The method of claim 1 wherein said generating step further includes submitting a round trip order to an exchange that includes:
a first trade order for trading the financial instrument at said trade price; and
a second trade order for trading the financial instrument at a round trip price that is different than the trade price of the first trade order, wherein the difference between the trade price and the round trip price represents the trader's profit.

10. The method of claim 9, further comprising:
establishing an edge value representing an amount a trader wishes to make when trading the financial instrument; and
wherein said trade price is further determined based on the established edge value.

11. The method of claim 10 wherein said generating step further includes submitting a round trip order to an exchange that includes:
a first trade order for trading the financial instrument at a trade price equal to said future price plus the established edge value; and
a second trade order for trading the financial instrument at the trade price minus the established edge value.

12. The method of claim 11, further comprising:
establishing a hedge offset value representing an amount a trader is willing to forego making as a profit when trading the financial instrument; and
wherein said second trade order is traded at the trade price minus the established edge value plus the established hedge offset value.

13. The method of claim 1 wherein said plurality of analytic values is produced from an analysis of market data containing pricing information for the financial instrument.

14. The method of claim 1 wherein said plurality of analytic values is specified by the trader.

15. The method of claim 1 wherein said predictive model includes at least a first analytic level containing first level analytic values divided into two or more first level nodes and a second analytic level containing second level analytic values divided into two or more second level nodes, and said generating step further includes generating one or more trade orders for trading the financial instrument at an electronic exchange when the future price indicator associated with a second level node to which a current second level analytic value relates meets a trader's criteria for trading.

16. A computer-implemented method for trading a financial instrument based on a model of assumed price behavior of the financial instrument, said method comprising:
providing a predictive model representing assumed price behavior of a financial instrument, said predictive model including one or more analytic levels, each of said one or more analytic levels having a plurality of analytic values divided into two or more nodes wherein each node is associated with a future price indicator that represents an assumed future price of the financial instrument;
producing a current analytic value in real time for each of said one or more analytic levels;
relating each current analytic value to one of the nodes of a corresponding analytic level of the predictive model;
establishing an edge value representing an amount a trader wishes to make when trading the financial instrument; and
generating one or more trade orders for trading the financial instrument at one or more electronic exchanges at a trade price that is determined based on the future price indicator associated with a node to which the current analytic value relates and the established edge value.

17. The method of claim 16 wherein each of said future price indicator and edge value is a measure of the financial instrument's tick size.

18. The method of claim 16 wherein each of said future price indicator and edge value is a measure of a currency amount.

19. The method of claim 16 wherein said future price indicator is a price offset representing a difference between a current price of the financial instrument and a price of the financial instrument at a later time.

20. The method of claim 19 wherein said later time is 2,000 milliseconds.

21. The method of claim 16 wherein said generating step further includes submitting a resting order to an exchange that rests on an order book for the financial instrument until the trader's criteria for trading is met.

22. The method of claim 16, further comprising:
re-calculating the trade price based on an updated current analytic value and corresponding future price indicator as market conditions change; and
modifying the trade price of at least one of said one or more trade orders when re-pricing results in a new future price indicator.

23. The method of claim 16 wherein said generating step further includes submitting a round trip order to an exchange that includes:
a first trade order for trading the financial instrument at a trade price equal to said future price plus the established edge value; and
a second trade order for trading the financial instrument at the trade price minus the established edge value.

24. The method of claim 23, further comprising:
establishing a hedge offset value representing an amount a trader is willing to forego making as a profit when trading the financial instrument; and
wherein said second trade order is traded at the trade price minus the established edge value plus the established hedge offset value.

25. The method of claim 16 wherein said plurality of analytic values is produced from an analysis of market data containing pricing information for the financial instrument.

26. The method of claim 16 wherein said plurality of analytic values is specified by a user.

27. An apparatus for allowing a trader to submit trade orders for a financial instrument from an electronic processing device to an electronic exchange, the apparatus comprising:
a graphical user display device;
a user input device;
a communication network for electronically communicating with an electronic exchange; and
a programmable electronic processing device in communication with the display device, user input device, and communication network, the electronic processing device being programmed to take the following actions in response to input received from the user input device:
obtain a future price indicator for the financial instrument by comparing a current analytic value representing current price behavior of the financial instrument to analytic values contained within a predictive model having one or more analytic levels representing assumed price behavior of the financial instrument; and
generate one or more trade orders for trading the financial instrument at one or more electronic exchanges via the communication network at a trade price that is determined based on the future price indicator.

28. The apparatus of claim 27 wherein said future price indicator is obtained by comparing each of two or more current analytic values to corresponding sets of analytic values contained within a multi-level predictive model.

29. The apparatus of claim 27 wherein said future price indicator is measured in units of the financial instrument's tick size.

30. The apparatus of claim 27 wherein said future price indicator is measured in units of a currency amount.

31. The apparatus of claim 27 wherein said user input device is a computer mouse with buttons.

32. The apparatus of claim 27 wherein said user input device is a keyboard.

33. The apparatus of claim 27 wherein said one or more trade orders includes a resting order that rests on an order book for the financial instrument until the trader's criteria for trading is met.

34. The apparatus of claim 27 wherein said processing device is further operable to:
re-calculate the trade price based on an updated current analytic value and corresponding future price indicator as market conditions change; and
modify the trade price of at least one of said one or more trade orders when re-pricing results in a new future price indicator.

35. The apparatus of claim 27 wherein said one or more trade orders includes:
a first trade order for trading the financial instrument at said trade price; and
a second trade order for trading the financial instrument at a round trip price that is different than the trade price of the first trade order, wherein the difference between the trade price and the round trip price represents the trader's profit.

36. The apparatus of claim 35 wherein said processing device is further operable to:
establish an edge value representing an amount a trader wishes to make when trading the financial instrument; and
wherein said trade price is further determined based on the established edge value.

37. The apparatus of claim 36 wherein said one or more trade order further includes:
a first trade order for trading the financial instrument at a trade price equal to said future price plus the established edge value; and
a second trade order for trading the financial instrument at the trade price minus the established edge value.

38. The apparatus of claim 37 wherein said processing device is further operable to:
establish a hedge offset value representing an amount a trader is willing to forego making as a profit when trading the financial instrument; and
wherein said second trade order is traded at the trade price minus the established edge value plus the established hedge offset value.

39. An apparatus for allowing a trader to submit trade orders for a financial instrument from an electronic processing device to an electronic exchange, the apparatus comprising:
a graphical user display device;
a user input device;
a communication network for electronically communicating with an electronic exchange; and
a programmable electronic processing device in communication with the display device, user input device, and communication network, the electronic processing device being programmed to take the following actions in response to input received from the user input device:
display a graphical control interface on the display device, the graphical control interface including a plurality of edge values, each of said plurality of edge values representing an amount a trader wishes to make on a trade of a financial instrument;
obtain a future price indicator for the financial instrument by comparing a current analytic value representing current price behavior of the financial instrument to analytic values contained within a predictive model having one or more analytic levels representing assumed price behavior of the financial instrument; and
in response to a selection of an edge value from the graphical control interface with the user input device, generate one or more trade orders for trading the financial instrument at one or more electronic exchanges via the communication network at a trade price that is determined based on the future price indicator and the selected edge value.

40. The apparatus of claim 39 wherein said future price indicator is obtained by comparing each of two or more current analytic values to corresponding sets of analytic values contained within a multi-level predictive model.

41. The apparatus of claim 39 wherein said user input device is a computer mouse having an onscreen pointer, a left mouse button, and a right mouse button.

42. The apparatus of claim 39 wherein a click of the left mouse button while the onscreen pointer is positioned over the graphical control interface causes the processing device to generate a Bid order.

43. The apparatus of claim 39 wherein a click of the right mouse button while the onscreen pointer is positioned over the graphical user interface causes the processing device to generate an Ask order.

44. The apparatus of claim 39 wherein said user input device is a keyboard.

45. The apparatus of claim 39 wherein each of said future price indicator and edge value is a measure of the financial instrument's tick size.

46. The apparatus of claim 39 wherein each of said future price indicator and edge value is a measure of a currency amount.

47. The apparatus of claim 39 wherein each of said future price indicator and edge value is a price offset representing a difference between a current price of the financial instrument and a price of the financial instrument at a later time.

48. The apparatus of claim 47 wherein said later time is 2,000 milliseconds.

49. The apparatus of claim 39 wherein said one or more trade orders includes a resting order that rests on an order book for the financial instrument until the trader's criteria for trading is met.

50. The apparatus of claim 39 wherein said generating step further includes submitting a snipe order to an exchange when the predicted future price change meets the edge value.

51. The apparatus of claim 39 wherein said processing device is further operable to:
re-calculate the trade price based on an updated current analytic value and corresponding future price indicator as market conditions change; and
modify the trade price of at least one of said one or more trade orders when re-pricing results in a new future price indicator.

52. The apparatus of claim 39 wherein said one or more trade orders further includes:
a first trade order for trading the financial instrument at a trade price equal to said future price plus the established edge value; and
a second trade order for trading the financial instrument at the trade price minus the established edge value.

53. The apparatus of claim 52 wherein said processing device is further operable to:
establish an edge value representing an amount a trader wishes to make when trading the financial instrument; and
wherein said second trade order is traded at the trade price minus the established edge value plus the established hedge offset value.
